(19) United States
(12) Patent Application Publication
(10) Pub. No.: US 2008/0218736 A1
(43) Pub. Date: Sep. 11, 2008

(54) Evanescent Wave Sensing Apparatus and Methods Using Plasmons

(76) Inventor: Andrew Mark Shaw, Exeter (GB)

Correspondence Address: TAROLLI, SUNDHEIM, COVELL & TUMMINO L.L.P., 1300 EAST NINTH STREET, SUITE 1700, CLEVEVLAND, OH, 44114, US

(21) Appl. No.: 10/593,106

(22) PCT Filed: Mar. 15, 2005
(86) PCT No.: PCT/GB2005/050033

§ 371 Date: May 6, 2008

(30) Foreign Application Priority Data
Mar. 15, 2004 (GB) 0405815.2

(51) Int. Cl. G01N 21/00; G01N 21/55; G02B 6/00

(52) U.S. Cl. 356/72; 356/445; 385/12

(57) ABSTRACT

We describe sensing apparatus using evanescent-wave based optical cavity ring-down plasmon resonance techniques. An optical cavity is formed by a pair of highly reflective surfaces, said an optical path between said surfaces including a reflection from a totally internally reflecting (TIR) surface, the reflection from said TIR surface generating an evanescent wave. The TIR surface is provided with electrically conducting material such that the evanescent wave excites a plasmon within the material. A change in absorption of evanescent wave due to a change in said plasmon excitation is detectable to provide a sensing function. Advantageously light of two different wavelengths straddling the plasmon excitation is employed. Preferably the sensor is a fibre-optic evanescent wave surface plasmon sensor.

This invention is generally concerned with sensing apparatus, methods and techniques based upon cavity ring-down spectroscopy (CRDS), in particular evanescent-wave based techniques. These will be described with particular reference to plasmon resonance techniques.

Cavity Ring-Down Spectroscopy is known as a high sensitivity technique for analysis of molecules in the gas phase (see, for example, G. Berden, R. Peeters and G. Meijer, Int. Rev. Phys. Chem., 19, (2000) 565, P. Zalicki and R. N. Zare, J. Chem. Phys. 102 (1995) 2708, M. D. Levinson, B. A. Paldus, T. G. Spence, C. C. Harb, J. S. Harris and R. N. Zare, Chem. Phys. Lett. 290 (1998) 335, B. A. Paldus, C. C. Harb, T. G. Spence, B. Wilkie, J. Xie, J. S. Harris and R. N. Zare, J. App. Phys. 83 (1998) 3991. D. Romanini, A. A. Kachanov and F. Stoeckel, Chem. Phys. Lett. 270 (1997) 538). The CRDS technique can readily detect a change in molecular absorption coefficient of 10⁻⁶ cm⁻¹, with the additional advantage of not requiring calibration of the sensor at the point of measurement since the technique is able to determine an absolute molecular concentration based upon known molecular absorbance at the wavelength or wavelengths of interest. Although the acronym CRDS makes reference to spectroscopy in many cases measurements are made at a single wavelength rather than over a range of wavelengths.

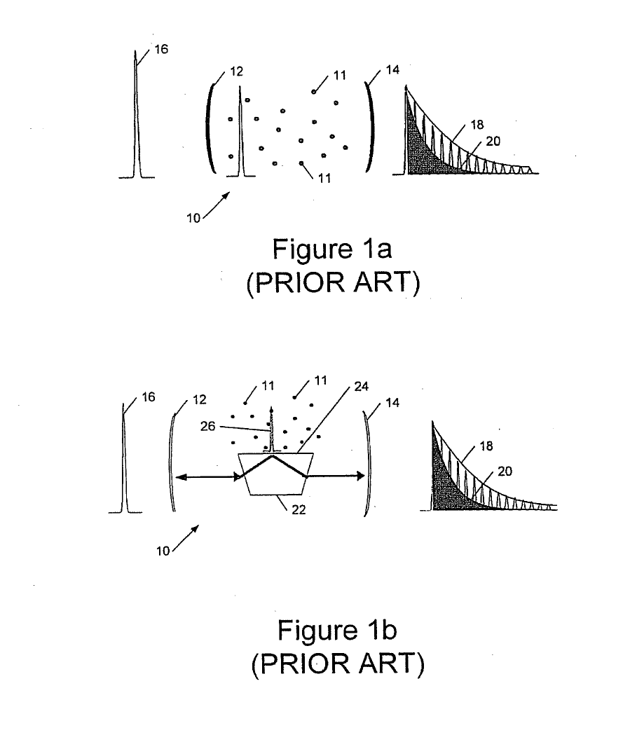

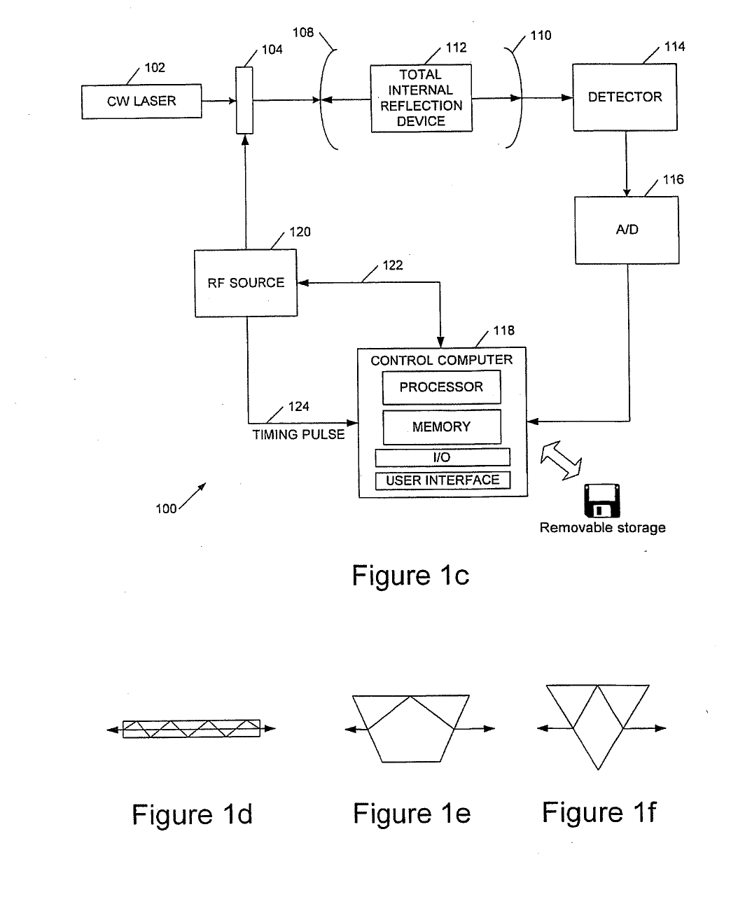

FIG. 1a, which shows a cavity 10 of a CRDS device, illustrates the main principles of the technique. The cavity 10 is formed by a pair of high reflectivity mirrors at 12, 14 positioned opposite one another (or in some other configuration) to form an optical cavity or resonator. A pulse of laser light 16 enters the cavity through the back of one mirror (mirror 12 in FIG. 1a) and makes many bounces between the mirrors, losing some intensity at each reflection. Light leaks out through the mirrors at each bounce and the intensity of light in the cavity decays exponentially to zero with a half-life decay time, τ. The light leaking from one or other mirror, in FIG. 1a preferably mirror 14, is detected by a photo multiplier tube (PMT) as a decay profile such as decay profile 18 (although the individual bounces are not normally resolved). Curve 18 of FIG. 1a illustrates the origin of the phrase “ring-down”, the light ringing backwards and forwards between the two mirrors and gradually decreasing in amplitude. The decay time τ is a measure of all the losses in the cavity, and when molecules 11 which absorb the laser radiation are present in the cavity the losses are greater and the decay time is shorter, as illustratively shown by trace 20.

Since the pulse of laser radiation makes many passes through the cavity even a low concentration of absorbing molecules (or atoms, ions or other species) can have a significant effect on the decay time. The change in decay time, Δ τ, is a function of the strength of absorption of the molecule at the frequency, v, of interest α (v) (the molecular extinction coefficient) and of the concentration per unit length, lₛ, of the absorbing species and is given by equation 1 below.

Δτ=tᵣ/{2(1−R)+α(v)lₛ} (Equation 1)

where R is the reflectivity of each of mirrors 12, 14 and tᵣ is the round trip time of the cavity, tᵣ=c/2L where c is the speed of light and L is the length of the cavity. Since the molecular absorption coefficient is a property of the target molecule, once Δτ has been measured the concentration of molecules within the cavity can be determined without the need for calibration.

It will be appreciated that to employ equation 1 measurements of the mirror reflectivities, the molecular absorption (or extinction) coefficient, the cavity length and (where different) the sample lengths are necessary but these may be determined in advance of any particular measurement, for example, during initial set up of a CRDS machine. Likewise since the decay times are generally relatively short, of the order of tens of nanoseconds, a timing calibration may also be needed, although again this may be performed when the apparatus is initially set up.

It will be further appreciated that to achieve a high sensitivity the reflectivities of mirrors 12, 14 should be high (whilst still permitting a detectable level of light to leak out) and typically R equals 0.9999 to provide of the order of 10⁴ bounces. If the total losses in the cavity are around 1% there will only be 3 or 4 bounces and consequently the sensitivity of the apparatus is very much reduced; in practical terms it is desirable to have total losses less than 0.25%, corresponding to around 200 bounces during decay time τ, or approximately 1000 bounces during ring down of the entire cavity.

One problem with CRDS is that the technique is only suitable for sensing molecules that are introduced into the cavity in a gas since if a liquid or solid is introduced into the cavity losses become very large and the technique fails. To address this problem so-called evanescent wave CRDS (e-CRDS) can be employed, as described in the Applicant's co-pending UK patent application no. 0302174.8 filed 30 Jan. 2003. Background prior art relating to e-CRDS can be found in U.S. Pat. No. 5,943,136, U.S. Pat. No. 5,835,231, U.S. Pat. No. 5,986,768, EP1195582A, A. J. Hallock et al. “Use of Broadband, Continuous-Wave diode Lasers in Cavity Ring-Down Spectroscopy for Liquid Samples”, Applied Spectroscopy, 57(5), 2003, 571-573, and D. Romanini et al, “CW cavity ring down spectroscopy”, Chem. Phys. Lett. 264 (1997) 316-322. Some background material relating to particle plasmon resonance (PPR) can be found in D. A. Shultz Current Opinion in Biotechnology 2003, 14, 13.

FIG. 1b, in which like elements to those of FIG. 1a are indicated by like reference numerals, shows the idea underlying evanescent wave CRDS. In FIG. 1b a prism 22 (as shown, a pellin broca prism) is introduced into the cavity such that total internal reflection (TIR) occurs at surface 24 of the prism (in some arrangements a monolithic cavity resonator may be employed). Total internal reflection will be familiar to the skilled person, and occurs when the angle of incidence (to a normal surface) is greater than a critical angle θ_{c} where sin θ_{c} is equal to n₂/n₁ where n₂ is the refracted index of the medium outside the prism and n₁ is the refractive index ofthe material of which the prism is composed. Beyond this critical angle light is reflected from the interface with substantially 100% efficiency back into the medium of the prism, but a non-propagating wave, called an evanescent wave (e-wave) is formed beyond the interface at which the TIR occurs. This e-wave penetrates into the medium above the prism but it's intensity decreases exponentially with distance from the surface, typically over a distance of the order of the a wavelength. The depth at which the intensity of the e-wave falls to 1/e (where e=2.718) of it's initial value is known at the penetration depth of the e-wave. For example, for a silica/air interface under 630 nm illumination the penetration depth is approximately 175 nm and for a silica/water interface the depth is approximately 250 nm, which may be compared with the size of a molecule, typically in the range 0.1-1.0 nm.

A molecule adjacent surface 24 and within the e-wave field can absorb energy from the e-wave illustrated by peak 26, thus, in effect, absorbing energy from the cavity. In such circumstances the “total internal reflection” is sometimes referred to as attenuated total internal reflection (ATIR). As with the conventional CRDS apparatus a loss in the cavity is detected as a change in cavity ring-down decay time, and in this way the technique can be extended to measurements on molecules in a liquid or solid phase as well as molecules in a gaseous phase. In the configuration of FIG. 1b molecules near the total internal reflection surface 24 are effectively in optical contact with the cavity, and are sampled by the e-wave resulting from the total internal reflection at the surface.

### SUMMARY OF THE INVENTION

Although the sensitivity of CRDS apparatus, in particular e-CRDS apparatus, is very high it is nonetheless desirable to provide further improvements in sensors based upon this general principle. The excitation of surface plasmons in a cavity ring-down detector has previously been described in A.C.R. Pipino et al., “Surface-plasmon-resonance-enhanced cavity ring-down detection”, J. Chem. Phys 120(3), 2004, 1585-1593. They describe a system that uses high reflectivity mirrors to provide a cavity in which an Au-coated optical flat is positioned at Brewster's angle (FIG. 1) to minimise cavity losses and hence facilitate ring-down. However this arrangement is cumbersome for apparatus which is intended for deployment “in the field”. Moreover the applicants have recognised that localised or particle plasmon resonance rather than surface plasmon resonance techniques may be employed for enhanced sensitivity.

According to a first aspect of the present invention there is therefore provided an evanescent wave cavity-based optical sensor, the sensor comprising: an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function; a light source to inject light into said cavity; and a detector to detect a light level within said cavity; and wherein said TIR surface is provided with an electrically conducting material over at least part of said TIR surface such that said evanescent wave excites a plasmon within said material; whereby a change in absorption of said evanescent wave due to a change in said plasmon excitation is detectable using said detector to provide said sensing function.

The invention also provides an evanescent wave cavity ring-down sensor comprising: a ring-down optical cavity including an attenuated total-internal-reflection based sensing device for sensing a substance modifying a ring-down characteristic of the cavity; a continuous wave light source for exciting said cavity; and a detector for monitoring said ring-down characteristic; and wherein said sensing device is provided with an electrically conducting material adjacent a total internal reflection (TIR) interface of said device such that an evanescent wave at said interface generates a plasmon excitation within said material, said plasmon excitation being modifiable by said sensed substance to modify said cavity ring-down characteristic.

In embodiments these sensors, by utilising plasmons excited by an evanescent wave in a cavity ring down system provide significantly enhanced sensitivity compared with previous techniques. The sensed substance may be biological or non-biological, living or non-living, examples including elements, ions, small and large molecules, groups of molecules, and bacteria and viruses. It may comprise a single substance, species or entity or a group of substances, species or entities.

In particularly preferred embodiments the sensing device comprises a fibre optic (FO) cable modified to enable plasmon-based sensing. This facilitates practical applications of the technology, in particular outside a lab environment, and the fabrication of inexpensive or even disposable sensing devices, for example for pregnancy or sugar tests. The modification may comprise removing a portion of the FO surface and/or tapering the FO; by controlling the degree of modification/taper the evanescent field (and plasmon coupling) may also be controlled and hence adapted to a particular sensing function or application.

Broadly speaking, in embodiments surface binding of a sensed substance to the conducting material modifies a plasmon resonance (PR) excited by the evanescent field, and since absorption within the cavity and ring-down (or up) is dominated by the PR, the characteristic ring-down (up) time is modified.

Thus according to a further aspect of the invention there is provided a sensor for a cavity of an evanescent-wave cavity ring down device, the sensor comprising a fibre optic cable having a core configured to guide light down the fibre surrounded by an outer cladding of lower refractive index than the core, wherein a sensing portion of the fibre optic cable is configured have a reduced thickness cladding provided with an electrically conducting material such that an evanescent wave from said guided light is able to excite a plasmon within said material.

The conducting material may comprise a substantially continuous or complete film on the TIR surface/interface, in which case the plasmon comprises a surface plasmon, but in some preferred embodiments the conducting material comprises one or more of islands of conducting material, particles, and aggregates, for example of particles, in which case the plasmon is better referred to as a localised plasmon or, in some instances, a particle plasmon. Thus, for example the electrical conducting material may comprise metallic regions having an average size of between 0.1 μm and 50 μm, in particular irregular islands and/or the electrical conducting material may comprise metallic particles having an average size of less than 50 nm. In general, especially for a surface plasmon based sensing instrument, it is preferable that the evanescent wave penetration depth is adjusted, for example by adjusting the angle of incidence (for a prism) or the taper profile or length (for a tapered fibre optic), to limit losses via the evanescent wave sufficiently to provide a plurality of optical passes within the cavity.

To provide a sensing surface metallic particles deposited from a colloid preparation can advantageously be employed, in embodiments relatively monodisperse colloid, so that the resulting film has a relatively well-defined average (mean) particle size, for example of 15 nm or 5 nm. In this way the one sigma size range may be kept within 30-50 nm, preferably within 10 nm, 5 nm or 2 nm. Particle size may be measured by a particle's lateral dimension (in the plane of the film), in particular by the maximum lateral dimension of a particle.

When metallic, particularly gold, particles are deposited by some techniques, in particular electron beam evaporation, the metallic surface comprises a series of islands, connected or disconnected regions of irregular shape and size (although having a size distribution). This may be achieved, for example, with an intended surface coverage of less than 10 nm, 5 nm or 1 nm. Generally the islands are larger than the colloid particle assemblies. The presence of islands appears to have an effect on the plasmon resonant response. For example the plasmon resonance may be shifted or modified, which may facilitate excitation/monitoring of PR absorbance and/or detection of a target species.

In other embodiments the conducting material may comprise a metallic film including irregular islands. This facilitates the excitation of localised plasmons as the resonant width is increased, thus reducing the precision with which the wavelength of an exciting laser needs to be matched to the PR. Although the precise mechanism is not fully understood such islands, or more generally a rough or irregular surface coverage also appears to increase sensitivity. For example with particles, aggregates and/or islands there appears to be an enhancement of plasmon resonance in the irregularities (gaps, nooks or crannies) between the particles, aggregates and/or islands, especially where at least some of the gaps, nooks or crannies have an opening of less than 10 nm, 5 nm or preferably 1 nm. The region above these gaps, nooks or crannies appears to be particularly sensitive especially for large molecules such as molecules having a dimension greater than 5 nm, such as protein molecules, which can straddle these.

Examples of a substantially non-continuous conducting layer suitable for the generation of localised plasmons include substantially non-continuous aggregates of nanoparticles and/or islands of particles. Structure within the aggregates (nooks and crannies) have provided regions of field enhancement and hence extreme sensitivity including attomolar measurements. Here the nanoparticles are sub-micron particles; the aggregates are preferably less than 100 nm across, generally working best in the range 1-50 nm. Broadly it is preferable that the structure of the layer of conducting material is on such a scale that Mie rather than Rayleigh scattering dominates (ie less than an operating wavelength).

One feature that is useful is the small shifts in the localised plasmons. The ability to measure small shifts in optical extinction associated with the plasmons makes the response intrincally linear wheras the sensitivity of other techniques requires big changes to be observed which are not genrally linear which changes the interepretion of the results. In protein binding or folding for instance it is important to know what changes in the protein rather than what is changing in the plasmon at the same time due to a large shift.

Another useful feature is that the plasmon has a finite extinction spectrum; a broad hump in wavelength space that is centred at a λ characteristic of the particle, aggregate or island size. Bigger particles have a longer central λ and vice versa. Thus different detection regimes are possible depending on the position of the interrogation wavelength, for example selecting particle or region size using wavelength. A resonance may be monitored on the top of the extinction maximum (to watch the change in extinction as the spectrum shifts in λ) or on one of the slopes. The apparatus can also be configured to monitor a differential signal, for example to see a decrease on the blue side of the resonance (spectrum) and a rise in the extinction on the red side (or vice-versa). Further (with single-ended or differential monitoring) detecting the signal change out on the red side of the plasmon resonance (extinction spectrum) enables the number of particles to be increased without causes extreme losses within the cavity, and hence the amount of particles and target species on the particles can be increased.

Evanescent field excitation of the particle plasmons can be controlled by changing the penetration depth of the radiation and specifically the taper profile of the to allow for larger extinction on the surface which removes a controlled amount of radiation from the surface. We can then sit on top of a very strong plasmon extinction but only be sensitive at a level that is tolerable within the loss budget of the cavity. We can play with all of the parameters to optimise the detection.

The spectral width of the extinction spectrum (of a localised plasmon) is generally less than 500 nm, typically of order 100 nm, and it is thus easy to allow for more than one wavelength to be present within the spectrum say on the blue side and on the red side of the resonance. In this way we can measure a simultaneous increase and decrease in the signal associated with a shift such as a red (or blue) shift of the plasmon. By contrast this is very difficult with continuous surfaces as the plasmon absorbance is spread over the spectrum and the changes are much less dramatic.

The change in the refractive index above the particles due to binding (specific and/or non-specific) in embodiments is the basis of the technique. The applicant has observed changes as small as 10⁻⁵ refractive index units (RIU) without the two-wavelength straddling detection.

Advantageously the conducting material may be functionalised by attaching to its surface another material, for example comprising sensitising or selecting entities, which has an affinity with or a selective response to a particular substance or material or groups of substances or materials. The material or entities may comprise a chemical (such as a molecule or molecular group) and/or protein and/or antibody and/or DNA/RNA and may be provided as a partial or substantially complete coating or overlay on a film or layer of the conducting material. This facilitates more selective and/or sensitive detection, enabling, for example, the construction of an oestrogen sensor. The surface may be functionalised with, for example, antibodies, or with any molecules having a specific response to a target or target group.

In the sensing systems described above and below polarisation maintaining fibre may advantageously be employed. This facilitates, for example measurement in the plane of the polarization and comparison of the result with another measurement, for example in a different plane or with a measurement from an un-polarised cavity. This may provide, for example, a measure of a dichroic ratio, which may be employed, for example, in the determination of a molecular orientation such as which way up a molecule is bound to the surface.

The invention also provides an optical cavity including a TIR surface or interface as described above. The skilled person will understand that such the optical cavity may be provided without one or both mirrors since these may be provided by the cavity sensing apparatus within which the TIR surface or interface is to operate.

It would also be advantageous to be able to refresh the sensing surface/interface, although this is not necessary for, for example, disposable sensors. Use of a conducting, for example, gold surface plasmon sensing surface enables an electric charge to be placed at the interface.

Thus in another aspect the invention provides a method of refreshing a plasmon-based sensing device, the device comprising a layer of conducting material optionally with a functionalised surface, the method comprising applying an electrical charge or potential to the conducting material to refresh the device.

In a related aspect the invention provides a plasmon-based sensing device comprising a sensing surface bearing a layer of conducting material, and including a sensing surface refresh system.

In embodiments this invention provides a plasmon-based sensing device comprising a layer of conducting material optionally with a functionalised surface, and including means to apply an electrical charge or potential to the conducting material to refresh the device.

It has been recognised that the conducting material or surface of a plasmon based sensor can be switched electrically between one state and another and that this brings energy to the sensor surface that can be harnessed to refresh it. For example electrical polarity changes at the interface, mediated by a charged surface of metal or conducting polymer, can be used to reverse the potential on a surface of the conducting material initiating a change in the binding constant of a detected ligand. Thus the electrical charge or potential can be switched between sensing and refreshing states, and optionally reversed, to refresh a sensing surface.

### Further Features and Advantages of Preferred Arrangements

Further features and advantages of some implementations of the above described systems will now be described. These have previously been set out in detail in the Applicant's co-pending International patent application number PCT/GB2004/000020, filed on 8 Jan. 2004, the entire contents of which are hereby incorporated by reference.

The sensitivity of an e-CRDS or a conventional CRDS-based device may be improved by taking a succession of measurements and averaging the results. However the frequency at which such a succession of measurements can be made is limited by the maximum pulse rate of the pulsed laser employed for injecting light into the cavity. This limitation can be addressed by employing a continuous wave (CW) laser such as a laser diode, since such lasers can be switched on and off faster than a pulsed laser's maximum pulse repetition rate. However, there are significant difficulties associated with coupling light from a CW laser into the cavity, particularly where a so-called stable cavity is employed, typically comprising planar or concave mirrors.

We have previously described, in UK patent application no. 0302174.8, how these difficulties may be addressed by employing a cavity ring-down sensor with a light source, such as a continuous wave laser, of a power and bandwidth sufficient to overcome losses within the cavity and couple energy into at least two modes of oscillation (either transverse or longitudinal) of the cavity. Preferably the light source is operable as a substantially continuous source and has a bandwidth sufficient to provide at least a half maximum power output across a range of frequencies equal to at least a free spectral range of the cavity. This facilitates coupling of light into the cavity even when modes of the light source and cavity are not exactly aligned. The light source may be shuttered or electronically controlled so that the excitation may be cut off to allow measurement of a ring-down decay curve. To facilitate accurate measurement of a ring-down time the CW light source output is preferably cut off in less than 100 ns, more preferably less than 50 ns. When driven with a CW laser the cavity preferably has a length of greater than 0.5 m more preferably greater than 1.0 m because a longer cavity results in closer spaced longitudinal modes.

In general the evanescent wave may either sense a substance directly or may mediate a sensing interaction through sensing a substance or a property of a material. The detector detects a change in light level in the cavity resulting from absorption of the evanescent wave, and whilst in practice this is almost always performed by measuring a ring-down characteristic of the cavity, in principle a ring-up characteristic of a cavity could additionally or alternatively be monitored. As the skilled person will appreciate the reflecting surfaces of the cavity are optical surfaces generally characterized by a change in reflective index, and may physically comprise internal or external surfaces.

The number of passes light makes through the cavity depends upon the Q of the cavity which, for most (but not all) applications, should be as high as possible. Although the cavity ring-down is responsive to absorption in the cavity this absorption may either be direct absorption by a sensed material or may be a consequence of some other physical effect, for example surface plasmon resonance (SPR) or measured property.

We have also previously described, in UK patent application no. 0302174.8, how in a preferred embodiment the cavity comprises a fibre optic cable with reflective ends. In embodiments this provides a number of advantages including physical and optical robustness, physically small size, durability, ease of manufacture, and flexibility, enabling use of such a sensor in a wide range of non lab-based applications.

To provide an evanescent-wave sensor a fibre optic cable may be modified to provide access to an evanescent field of light guided within the cable. The invention provides a fibre-optic sensor of this sort, for example for use in evanescent wave cavity ring-down device of the general type described above.

A fibre optic cable typically comprises a core configured to guide light down the fibre surrounded by an outer cladding of lower refractive index than the core. A sensing portion of the fibre optic cable may be configured have a reduced thickness cladding over part or all of the circumference of the fibre such that an evanescent wave from said guided light is accessible for sensing. By reducing the thickness of the cladding, in embodiments to expose the core, the evanescent wave can interact directly with a sensed material or substance or attenuation of light within the cavity via absorption of the evanescent wave can be indirectly modified, for example in an SPR-based sensor by modifying the interaction of a surface plasmon excited in overlying conductive material with the evanescent wave (a shift or modification of a plasmon resonance changing the absorption).

One, or preferably both ends of the fibre optic cable may be provided with a highly reflecting surface such as a Bragg stack. The fibre optic cable thus provides a stable cavity, that is guided light confined within the cable will retrace its path many times. Preferably the fibre optic cable (and hence cavity) has a length of at least a length of 0.5 m, and more preferably of at least 1.0 m, to facilitate coupling of a continuous wave laser to the fibre optic sensor, as described above. The sensor may be coupled to a fibre optic extension and, optionally, may include an optical fibre amplifier; such an amplifier may be incorporated within the cavity.

The fibre optic cable is preferably a step index fibre, although a graded index fibre may also be used, and may comprise a single mode or polarization-maintaining or high birefringence fibre. Preferably the sensing portion of the cable has a loss of less than 1%, more preferably less than 0.5%, most preferably less than 0.25%, so that the cavity has a relatively high Q and consequently a high sensitivity. Where the sensor is to be used in a liquid the core of the fibre should have a greater refractive index than that of the liquid in which it is to be immersed in order to restrict losses from the cavity. The sensor may be attached to a Y-coupling device to facilitate single-ended use, for example inside a human or animal body.

The skilled person will understand that features and aspects of the above described sensors and apparatus may be combined.

In all the above aspects of the invention references to optical components and to light includes components for and light of non-visible wavelengths such as infrared and other light.

These and other aspects of the present invention will now be further described, by way of example only, with reference to the accompanying figures:

FIGS. 1a-1f show, respectively, an operating principle of a CRDS-type system, an operating principle of an e-CRDS-type system, a block diagram of a continuous wave e-CRDS system, and first, second and third total internal reflection devices for a CW e-CRDS system;

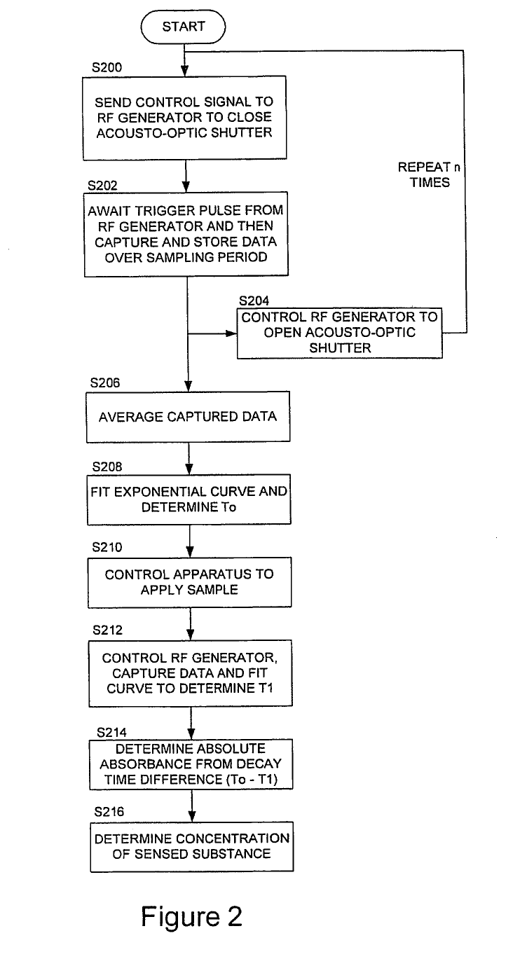

FIG. 2 shows a flow diagram illustrating operation of the system of FIG. 1c;

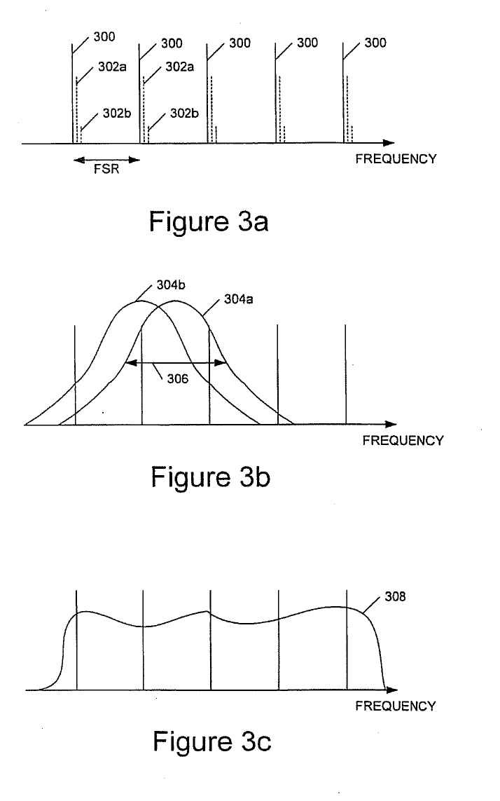

FIGS. 3a-3c show, respectively, cavity oscillation modes for the system of FIG. 1c, a first spectrum of a CW laser for use with the system of FIG. 1c, and a second CW laser spectrum for use with the system of FIG. 1c;

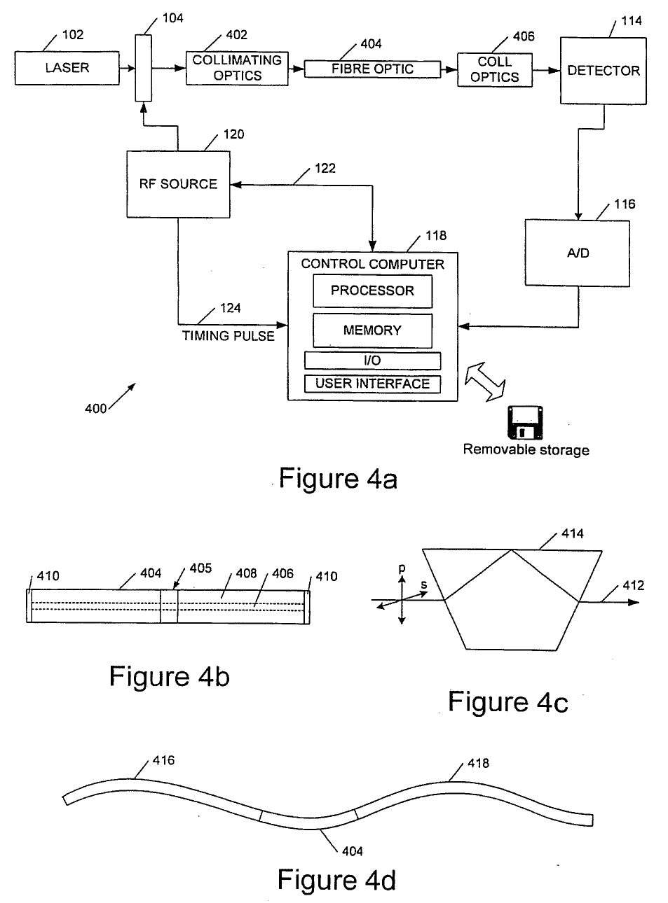

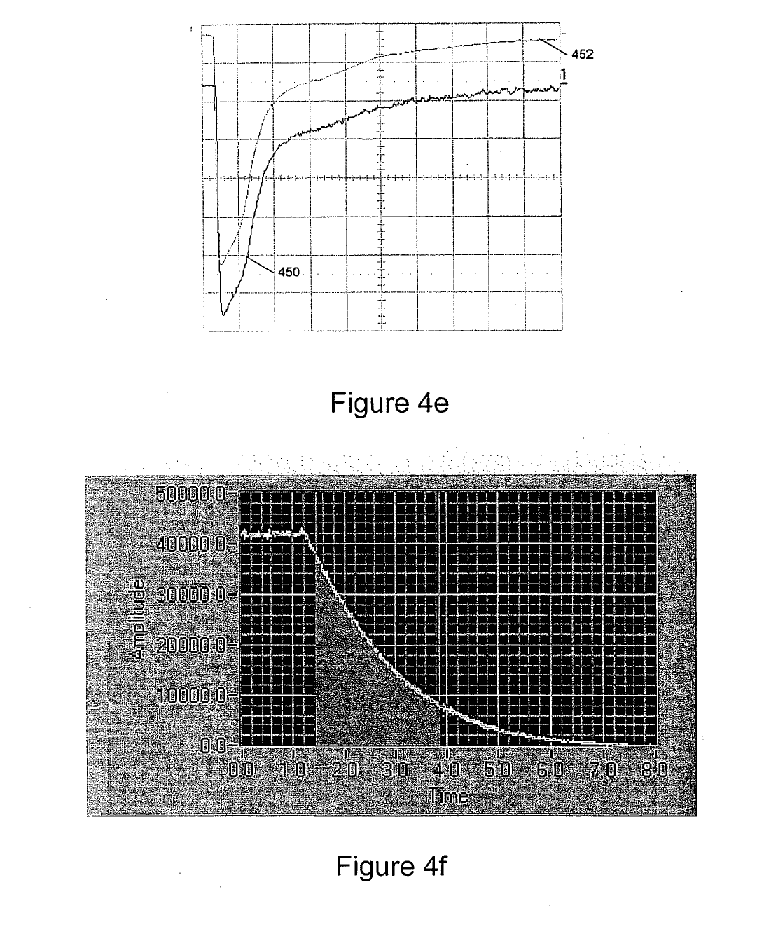

FIGS. 4a-4f show, respectively, a fibre optic-based e-CRDS system, a fibre optic cable for the system of FIG. 4a, an illustration of the effect of polarization in a total internal reflection device, a fibre optic cavity-based sensor, and examples of fibre optic cavity ring-down profiles;

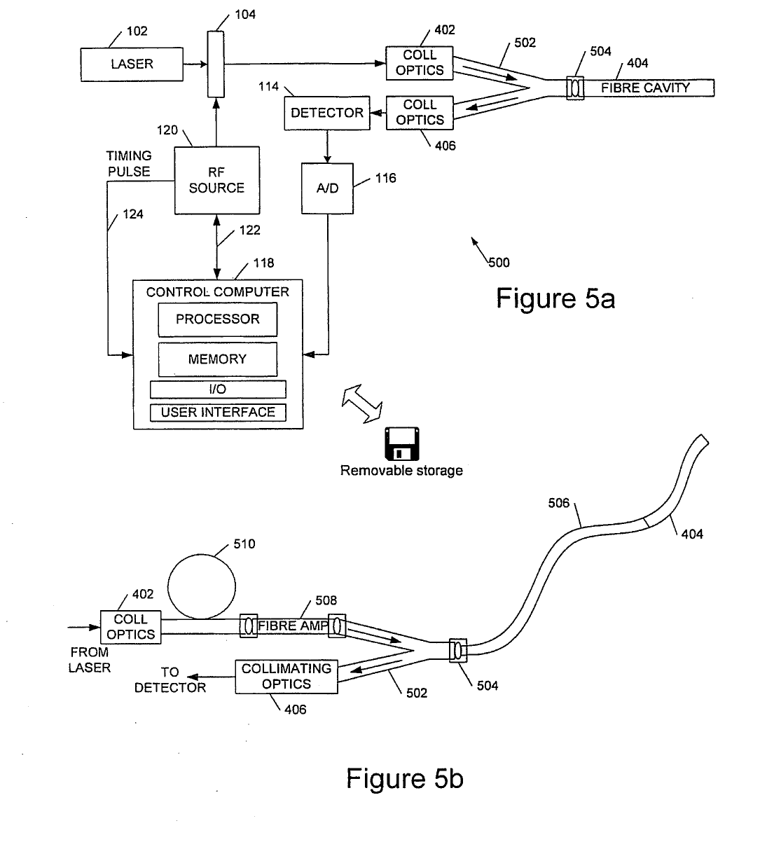

FIGS. 5a and 5b show, respectively, a second fibre optic based e-CRDS device, and a variant of this device;

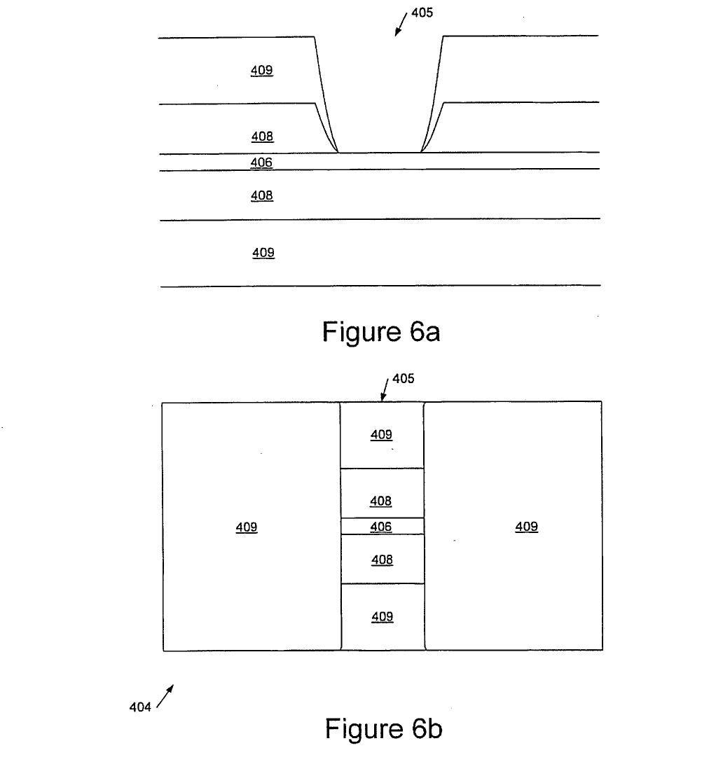

FIGS. 6a and 6b show, respectively, a cross sectional view and a view from above of a sensor portion of a fibre optic cavity;

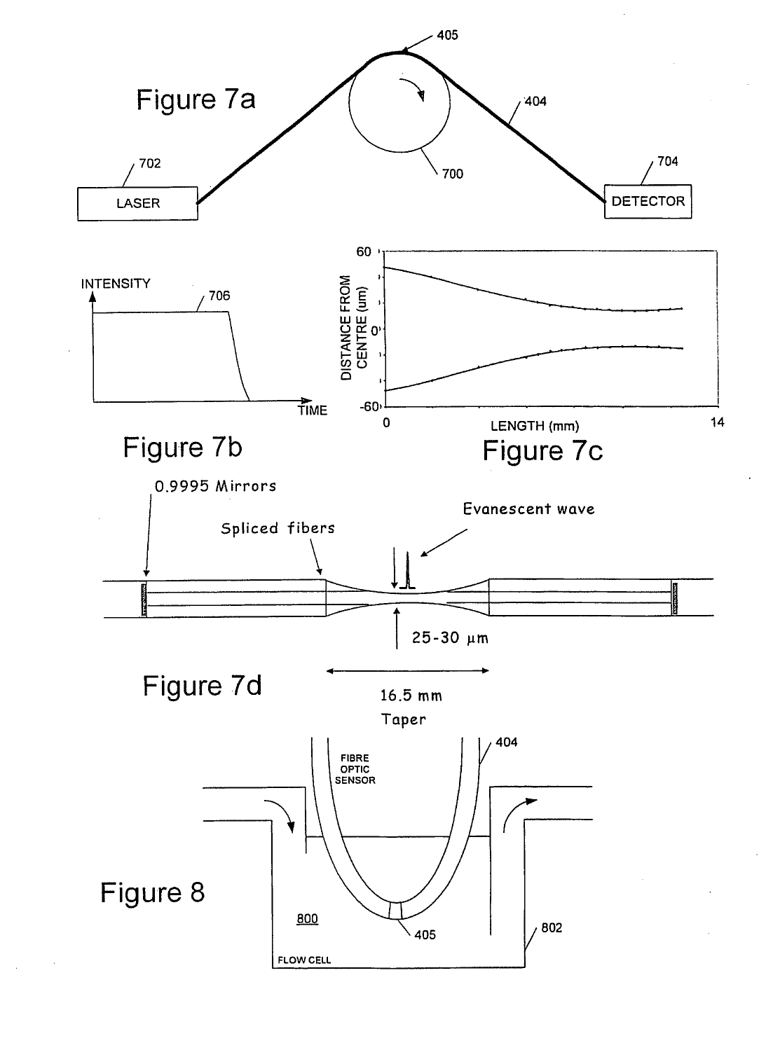

FIGS. 7a to 7d show, respectively, a procedure for forming the sensor portion of FIG. 6, a detected light intensity-time graph associated with the procedure of FIG. 7a, a taper profile, and a tapered FO sensing device;

FIG. 8 shows an example of an application of an e-CRDS-based fibre optic sensor;

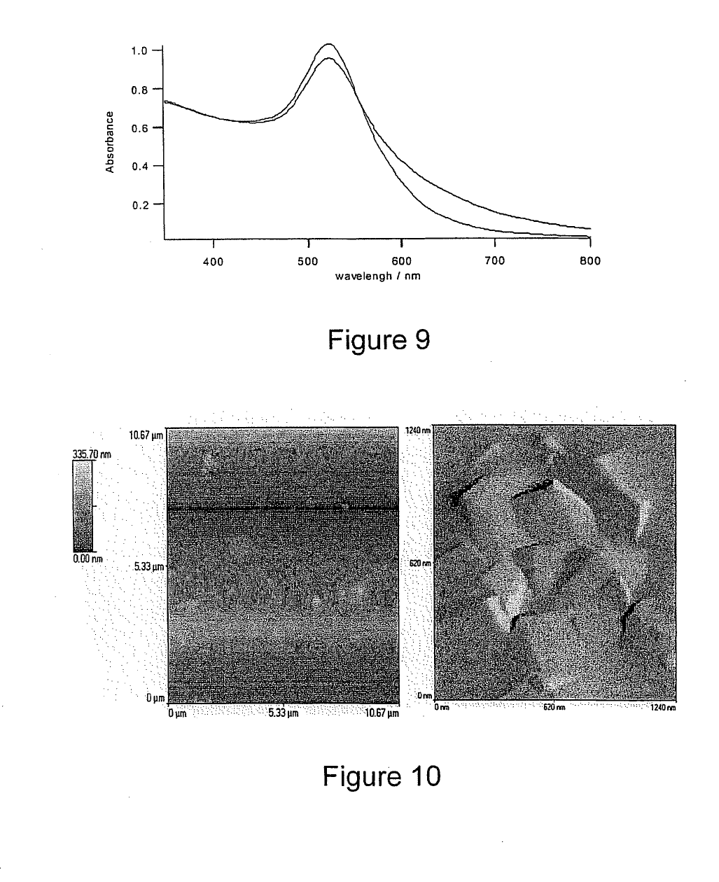

FIG. 9 shows absorption spectrum for 350 mg of disodium citrate gold colloid for a) aqueous colloid preparation colloid, b) organic colloid preparation; both have a particle size distribution centred at 15 nm.

FIG. 10 shows AFM studies of the evaporation-deposited gold surfaces.

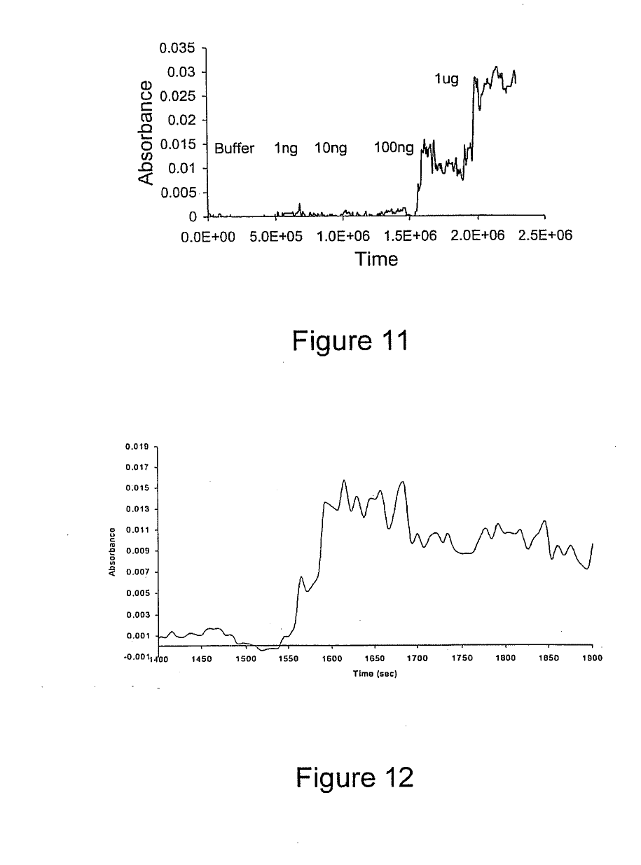

FIG. 11 shows SPR response for BSA binding studies.

FIG. 12 shows BSA binding curve kinetics.

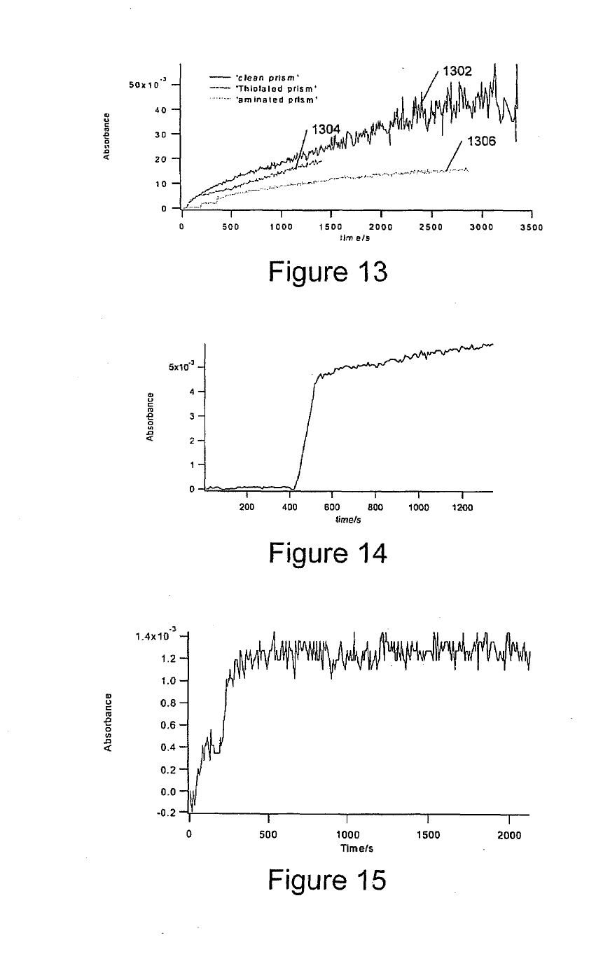

FIG. 13 shows absorbance change with time for 0.01 ml gold on prism surface.

FIG. 14 shows absorption kinetics of 15 nm gold colloid onto the prism surface.

FIG. 15 shows absorbance variation with time for 1 gl⁻¹ BSA on gold colloid at 55°.

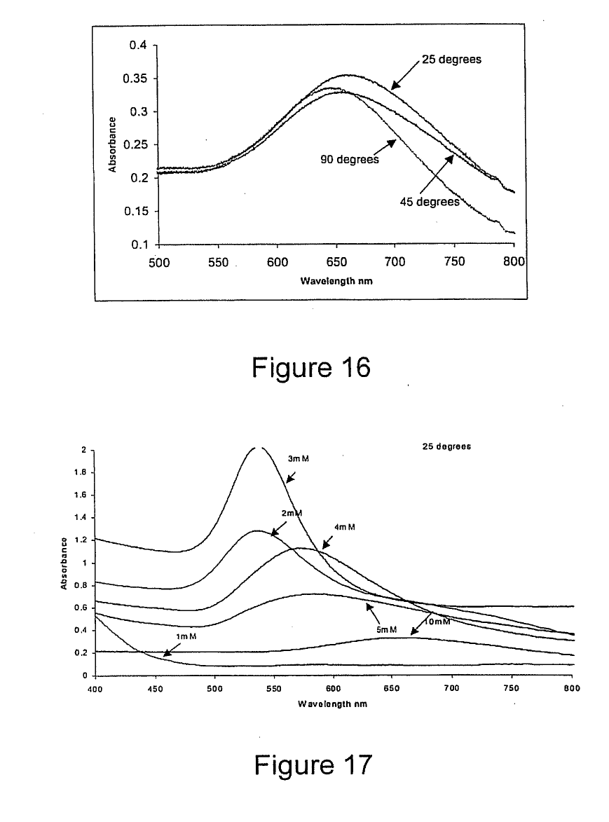

FIG. 16 shows visible absorption spectrum variation with colloid preparation temperature.

FIG. 17 shows the variation of the visible spectrum of the colloid with gold conentration at a constant preparation temperature of 25° C.

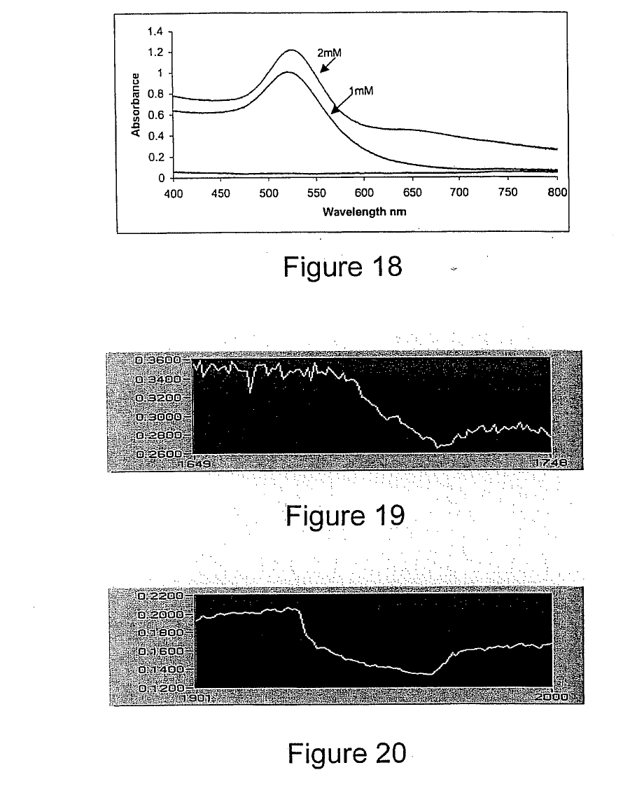

FIG. 18 shows variation in visible spectrum of the colloid with gold salt concentration at 95° C.

FIG. 19 shows a 10% colloid solution absorption kinetics followed by added water.

FIG. 20 shows 50% colloid solution absorption kinetics followed by added water.

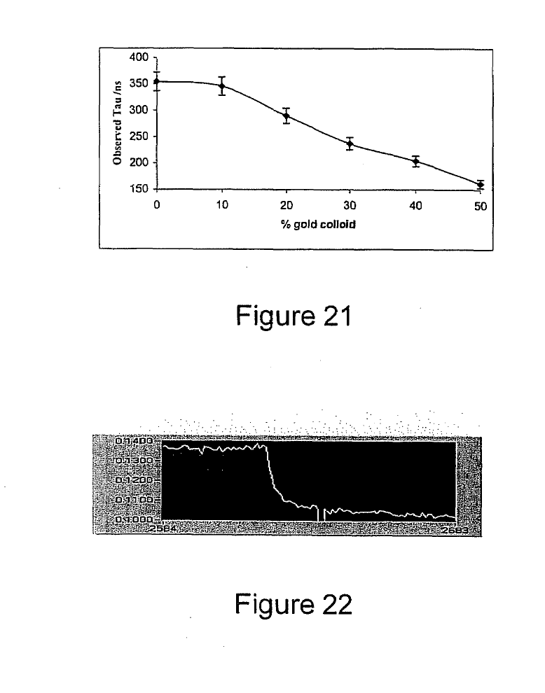

FIG. 21 shows FIG. 21 shows τ variation with colloid concentration.

FIG. 22 shows a binding curve measured in real time for 1 pg ml⁻¹ of BSA.

### Cavity Ring-Down Sensing Apparatus

We will first describe details of some particular preferred examples of e-CRDS-based sensing apparatus and will then, with particular reference to FIG. 9 onwards, describe techniques and improvements embodying aspects of the present invention.

Referring now to FIG. 1c, this shows an example of an e-CRDS-based system 100, in which light is injected into the cavity using a continuous wave (CW) laser 102. In the apparatus 100 of FIG. 1c the ring-down cavity comprises high reflectivity mirrors 108, 110 and includes a total internal reflection device 112. Mirrors 108 and 110 may be purchased from Layertec, Ernst-Abbe-Weg 1, D-99441, Mellingen, Germany. In practice the tunability of the system may be determined by the wavelength range over which the mirrors provide an adequately high reflectivity. Light is provided to the cavity by laser 102 through the rear of mirror 108 via an acousto-optic (AO) modulator 104 to control the injection of light. In one embodiment the output of laser 102 is coupled into an optical fibre and then focused onto a AO modulator 104 with 100 micron spot, the output from AOM 104 then can be collected by a further fibre optic before being introduced into the cavity resonator. This arrangement facilitates chop times of the order of 50 ns, such fast chop times being desirable because of the relatively low finesse of the cavity resonator.

Laser 102 may comprise, for example, a CW ring dye laser operating at a wavelength of approximately 630 nm or some other CW light source, such as a light emitting diode may be employed. For reasons which will be explained further below, the bandwidth of laser (or other light source) 102 should be greater than one free spectral range of the cavity formed by mirrors 108, 110 and in one dye laser-based embodiment laser 102 has a bandwidth of approximately 5 GHz. A suitable dye laser is the Coherent 899-01 ring-dye laser, available from Coherent Inc, California, USA. Use of a laser with a large bandwidth excites a plurality of modes of oscillation of the ring-down cavity and thus enables the cavity be “free running”, that is the laser cavity and the ring-down cavity need not rely on positional feedback to control cavity length to lock modes of the two cavities together. The sensitivity of the apparatus scales with the square root of the chopping rate and employing a continuous wave laser with a bandwidth sufficient to overlap multiple cavity modes facilitates a rapid chop rate, potentially at greater than 100 KHz or even greater than 1 MHz.

A radio frequency source 120 drives AO modulator 104 to allow the CW optical drive to cavity 108, 110 to be abruptly switched off (in effect the AO modulator acts as a controllable diffraction grating to steer the beam from laser 102 into or away from cavity 108, 100). A typical cavity ring-down time is of the order of a few hundred nanoseconds and therefore, in order to detect light from a significant number of bounces in the cavity, the CW laser light should be switched off in less than 100 ns, and preferably in less than about 30 ns. Data collected during this initial 100 ns period, that is data from an initial portion of the ring-down before the laser has completely stopped injecting light into the cavity, is generally discarded. To achieve such a fast switch-off time with the above mentioned dye laser an AO modulator such as the LM250 from Isle Optics, UK, may be used in conjunction with a RF generator such as the MD250 from the same company.

The RF source 120 and, indirectly, the AO modulator 104, is controlled by a control computer 118 via an IEEE bus 122. The RF source 120 also provides a timing pulse output 124 to the control computer to indicate when light from laser 102 is cut off from the cavity 108-110. It will be recognized that the timing edge of the timing pulse should have arise or fall time comparable with or preferably faster than optical injection shut-off time.

Use of a tunable light source such as a dye laser has advantages for some applications but in other applications a less tunable CW light source, such as a solid state diode laser may be employed, again in embodiments operating at approximately 630 nm. It has been found that a diode laser may be switched off in around 10 ns by controlling the electrical supply to the laser, thus providing a simpler and cheaper alternative to a dye laser for many applications. In such an embodiment RF source 120 is replaced by a diode laser driver which drives laser 102 directly, and AO modulator 104 may be dispensed with. An example of a suitable diode laser is the PPMT LD1338-F2, from Laser 2000 Ltd, UK, which includes a suitable driver, and a chop rate for the apparatus, and in particular for this laser, may be provided by a Techstar FG202 (2 MHz) frequency generator.

A small amount of light from the ring-down cavity escapes through the rear of mirror 110 and is monitored by a detector 114, in a preferred embodiment comprises a photo -multiplier tube (PMT) in combination with a suitable driver, optionally followed by a fast amplifier. Suitable devices are the H7732 photosensor module from Hammatsu with a standard power supply of 15V and an (optional) Ortec 9326 fast pre-amplifier. Detector 114 preferably has a rise time response of less than 100 ns more preferably less than 50 ns, most preferably less than 10 ns. Detector 114 drives a fast analogue-to-digital converter 116 which digitizes the output signal from detector 114 and provides a digital output to the control computer 118; in one embodiment an A to D on board a LeCroy waverunner LT 262 350 MHz digital oscilloscope was employed. Control computer 118 may comprise a conventional general purpose computer such as a personal computer with an IEEE bus for communication with the scope or A/D 116 may comprise a card within this computer. Computer 118 also includes input/output circuitry for bus 122 and timing line 124 as well as, in a conventional manner, a processor, memory, non-volatile storage, and a screen and keyboard user interface. The non-volatile storage may comprise a hard or floppy disk or CD-ROM, or programmed memory such as ROM, storing program code as described below. The code may comprise configuration code for LabView (Trade Mark), from National Instruments Corp, USA, or code written in a programming language such as C.

Examples of total internal reflection devices which may be employed for device 112 of FIG. 1c are shown in FIGS. 1d, 1e and 1f. FIG. 1d shows a fibre optic cable-based sensing device, as described in more detail later. FIG. 1e shows a first, Pellin Broca type prism, and FIG. 1f shows a second prism geometry. Prisms of a range of geometries, including Dove prisms, may be employed in the apparatus of FIG. 1c, particularly where an anti-reflection coating has been applied to the prism. The prisms of FIGS. 1e and 1f may be formed from a range of materials including, but not limited to glass, quartz, mica, calcium fluoride, fused silica, and borosilicate glass such as BK7.

Referring now to FIG. 2, this shows a flow diagram of one example of computer program code operating on control computer 118 to control the apparatus of FIG. 1c.

At step S200 control computer 118 sends a control signal to RF source 120 over bus 122 to control radio frequency source 120 to close AO shutter 104 to cut off the excitation of cavity 108-110. Then at step S202, the computer waits for a timing pulse on line 124 to accurately define the moment of cut-off, and once the timing pulse is received digitized light level readings from detector 114 are captured and stored in memory. Data may be captured at rates up to, for example, 1 G samples per second (1 sample/ns at either 8 or 16 bit resolution) preferably over a period of at least five decay lifetimes, for example, over a period of approximately 5 μs. Computer 118 then controls RF generator to re-open the shutter and the procedure loops back to step S200 to repeat the measurement, thereby capturing a set of cavity ring-down decay curves in memory.

When a continuous wave laser source is used to excite the cavity decay curves may be captured at a relatively high repetition rate. For example, in one embodiment decay curves were captured at a rate of approximately 20 kHz per curve, and in theory it should be possible to capture curves virtually back-to-back making measurements substantially continuously (with a small allowance for cavity ring-up time). Thus, for example, when capturing data over a period of approximately 5 μs it should be possible to repeat measurements at a rate of approximately 20 kHz. The data from the captured decay curves are then averaged at step S206, although in other embodiments other averaging techniques, such as a running average, may be employed.

At step S208 the procedure fits an exponential curve to the averaged captured data and uses this to determine a decay time τ₀ for the cavity in an initial condition, for example when no material to be sensed is present. The decay time τ₀ is the time taken for the light intensity to fall to 1/e of its initial value (e=2.718). Any conventional curve fitting method may be employed; one straight-forward method is to take a natural logarithm of the light intensity data and then to employ a least squares straight line fit. Preferably data at the start and end of the decay curve is omitted when determining the decay time, to reduce inaccuracies arising from the finite switch-off time of the laser and from measurement noise. Thus for example data between 20 percent and 80 percent of an initial maximum may be employed in the curve fitting. Optionally a baseline correction to the captured light intensity may be applied prior to fitting the curve; this correction may be obtained from an initial calibration measurement.

Following this initial decay time measurement computer 118 controls the apparatus to apply a sample (gas, liquid or solid) to the total internal reflection device 112 within the ring-down cavity; alternatively the sample may be applied manually. The procedure then, at step S212, effectively repeats steps S200-S208 for the cavity including the sample, capturing and averaging data for a plurality of ring-down curves and using this averaged data to determine a sample cavity ring-down decay time τ₁. Then, at step S214, the procedure determines an absolute absorption value for the sample using the difference in decay times (τ₀−τ₁) and, at step S216, the concentration of the sensed substance or species can be determined. This is described further below.

In an evanescent wave ring-down system such as that shown in FIG. 1c the total (absolute) absorbance can be deterinined from Δτ=τ₁−τ₀ using equation 2 below.

$$A b s = \frac{Δ t}{τ {τ}_{0}} ( \frac{{t}_{r}}{2} ) \qquad ( Equation 2 )$$

In equation 2 τᵣ is the round trip time for the cavity, which can be determined from the speed of light and from the optical path length including the total internal reflection device. The molecular concentration can then be determined using equation 3;

Absorbance=εCL (Equation 3)

where ε is the (molecular) extinction co-efficient for the sensed species, C is the concentration of the species in molecules per unit volume and L is the relevant path length, that is the penetration depth of the evanescent wave into the sensed medium, generally of the order of a wavelength. Since the evanescent wave decays away from the total internal reflection interface strictly speaking equation 3 should employ the Laplace transform of the concentration profile with distance from the TIR surface, although in practice physical interface effects may also come into play. A known molecular extinction co-efficient may be employed or, alternatively, a value for an extinction co-efficient for equation 3 may be determined by characterizing a material beforehand.

Referring next to FIG. 3a this shows a graph of frequencies (or equivalently, wavenumber) on the horizontal axis against transmission into a high Q cavity such as cavity 108, 110 of FIG. 1c, on the vertical axis. It can be seen that, broadly speaking, light can only be coupled into the cavity at discrete, equally-spaced frequencies corresponding to allowed longitudinal standing waves within the cavity known as longitudinal cavity modes. The interval between these modes is known as the free spectral range (FSR) of the cavity and is defined as equation 4 below.

FSR=(l/2c′) (Equation 4)

Where l is the length of the cavity and c′ is the effective speed of light within the cavity, that is the speed of light taking into account the effects of a non-unity refractive index for materials within the cavity. For a one-meter cavity, for example, the free spectral range is approximately 150 MHz. Lines 300 in FIG. 3a illustrate successive longitudinal cavity modes. FIG. 3a also shows (not to scale) a set of additional, transverse cavity modes 302a, b associated with each longitudinal mode, although these decay rapidly away from the longitudinal modes. The transverse modes are much more closely spaced than the longitudinal modes since they are determined by the much shorter transverse cavity dimensions. To couple continuous wave radiation into the cavity described by FIG. 3a the light source with sufficient bandwidth to overlap at least too longitudinal cavity modes may be employed. This is shown in FIG. 3b.

FIG. 3b shows FIG. 3a with an intensity (Watts per m²) or equivalently power spectrum 304a, b for a continuous wave laser superimposed. It can be seen that provided the full width at half maximum 306 of the laser output spans at least one FSR laser radiation should continuously fill the cavity, even if the peak of the laser output moves, as shown by spectra 304a and b. In practice the laser output may not have the regular shape illustrated in FIG. 3b and FIG. 3c illustrates, diagrammatically an example of the spectral output 308 of a dye laser which, broadly speaking, comprises a super imposition of a plurality of broad resonances at the cavity modes of the laser.

Referring again to FIG. 3b it can be seen that as the peak of the laser output moves, although two modes are always excited these are not necessarily the same two modes. It is desirable to continuously excite a cavity mode, taking into account shifts in mode position caused by vibration and/or temperature changes and it is therefore preferable that the laser output overlaps more than two modes, for example, five modes (as shown in FIG. 3c) or ten modes. In this way even if mode or laser frequency changes one mode at least is likely to be continuously excited. To cope with large temperature variations a large bandwidth may be needed and for certain designs of instruments, for example, fibre optic-based instruments it is similarly desirable to use a CW laser with a bandwidth of five, ten or more FSRs. For example a CW ring dye laser with a bandwidth of 5 GHz has advantageously employed with a cavity length of approximately one meter and hence an FSR of approximately 150 MHz.

For clarity transverse modes have not been shown in FIG. 3b or FIG. 3c but it will be appreciated light may be coupled into modes with a transverse component as well as a purely longitudinal modes, although to ensure continuous excitation of a cavity it is desirable to overlap at least two different longitudinal modes of the cavity

In order to excite a cavity mode sufficient power must be coupled into the cavity to overcome losses in the cavity so that the mode, in effect rings up. Preferably, however, at least half the maximum laser intensity at its peak frequency is delivered into at least two modes since this facilitates fast repetition of decay curve measurement and also increases sensitivity since decay curves will begin from a higher initial detected intensity. It will be appreciated that when the bandwidth of the CW laser overlaps with longitudinal modes of the ring-down cavity as described above, the power within the cavity depends on the incident power of the exciting laser, which enables the power within the cavity to be controlled, thus facilitating power dependent measurements and sensing.

FIG. 4a shows a fibre optic-based e-CRDS type sensing system 400 similar to that shown in FIG. 1c, in which like elements are indicated by like reference numerals. In FIG. 4a, however, mirrors 108, 110, and total internal reflection device 112 are replaced by fibre optic cable 404, the ends of which have been treated to render them reflective to form a fibre optic cavity. In addition collimating optics 402 are employed to couple light into fibre optic cable 404 and collimating optics 406 are employed to couple light from fibre optic cable 404 into detector 414.

FIG. 4b shows further details of fibre optic cable 404, which, in a conventional manner comprises a central core 406 surrounded by cladding 408 of lower refractive index than the core. Each end of the fibre optic cable 404 is, in the illustrated embodiment polished flat and provided with a multi layer Bragg stack 410 to render it highly reflective at the wavelength of interest. As the skilled person will be aware, a Bragg stack is a stack of quarter wavelength thick layers of materials of alternating refractive indices. To deposit the Bragg stacks the ends of the fibre optic cable are first prepared by etching away the surface and then polishing the etched surface flat to within, for example, a tenth of a wavelength (this polishing criteria is a commonly adopted standard for high-precision optical surfaces). Bragg stacks may then be deposited by ion sputtering of metal oxides; such a service is offered by a range of companies including the above-mentioned Layertec, Gmbh. Fibre optic cable 404 includes a sensor portion 405, as described further below.

Preferably optical fibre 404 is a single mode step index fibre, advantageously a single mode polarization preserving fibre to facilitate polarization-dependent measurements and to facilitate enhancement of the evanescent wave field. Such enhancement can be understood with reference to FIG. 4c which shows total internal reflection of light 412 at a surface 414. It can be seen from inspection of FIG. 4c that p-polarized light (within the plane containing light 412 and the normal to surface 414) generates an evanescent wave which penetrates further from surface 414 than does s-polarized light (perpendicular to the plane containing light 412 and the normal to surface 414).

The fibre optic cable is preferably selected for operation at a wavelength or wavelengths of laser 102. Thus, for example, where laser 102 operates in the region of 630 nm so called short-wavelength fibre may be employed, such as fibre from INO at 2470 Einstein Street, Sainte-Foy, Quebec, Canada. Broadly speaking suitable fibre optic cables are available over a wide range of wavelengths from less than 500 nm to greater than 1500 nm. Preferably low loss fibre is employed. In one embodiment single mode fibre (F601A from INO) with a core diameter of 5.6 μm (a cut-off at 540 nm, numerical aperture of 0.11, and outside diameter of 125 μm) and a loss of 7 dB/km was employed at 633 nm, giving a decay time of approximately 1.5 μs with a one meter cavity and an end reflectivity of R=0.999. In general the decay time is given by equation 5 below where the symbols have their previous meanings, ƒ is the loss in the fibre (units of m⁻¹ i.e. percentage loss per metre) and l is the length of the fibre in metres.

Δτ=tᵣ/{2(1−R)+ƒl} (Equation 5)

FIG. 4d illustrates a simple example of an alternative configuration of the apparatus of FIG. 4a, in which fibre optic cavity 404 is incorporated between two additional lengths of fibre optic cable 416, 418, light being injected at one end of fibre optic cable 416 and recovered from fibre optic cable 418, which provides an input to detector 114. Fibre optic cables 414, 416 and 418 may be joined in any conventional manner, for example using a standard FC/PC-type connector.

FIGS. 4e and 4f show examples of cavity ring-down decay curves obtained with apparatus similar to that shown in FIG. 4a with a cavity of length approximately one meter and the above mentioned single mode fibre. FIG. 4e shows two sampling oscilloscope traces captured at 500 mega samples per second with a horizontal (time) grid division of 0.2 μs and a vertical grid division of 50 μV. Curve 450 represents a single measurement and curve 452 and average of nine decay curve measurements (in FIG. 4e the curve has been displaced vertically for clarity) the decay time for the averaged decay curve 452 was determined to be approximately 1.7 μs. The slight departure from an exponential shape (a slight kink in the curve) during the initial approximately 100 ns is a consequence of coupling of radiation into the cladding of the fibre, which is rapidly attenuated by the fibre properties and losses to the surroundings.

Referring now to FIG. 5a this shows a variant of the apparatus of FIG. 4a, again in which like elements are indicated by like reference numerals. In FIG. 5a a single-ended connection is made to fibre cavity 404 although, as before, both ends of fibre 404 are provided with highly reflecting surfaces. Thus in FIG. 5a a conventional Y-type fibre optic coupler 502 is attached to one end of fibre cavity 404, in the illustrated example by an FC/PC screw connector 504. The Y connector 502 has one arm connected to collimating optics 402 and its second arm connecting to collimating optics 406. To allow laser light to be launched into fibre cavity 404 and light escaping from fibre cavity 404 to be detected from a single end of the cavity. This facilitates use of a fibre cavity-based sensor (such as is described in more detail below) in many applications, in particular applications where access both ends of the fibre is difficult or undesirable. Such applications include intra-venous sensing within a human or animal body and sensing within an oil well bore hole.

FIG. 5b shows a variant in which fibre cavity 404 is coupled to Y-connector 502 via an intermediate length of fibre optic cable 506 (which again may be coupled to cable 504 via a FC/PC connector). FIG. 5b also illustrates the use of an optional optical fibre amplifier 508 such as an erbium-doped fibre amplifier. In the illustrated example fibre amplifier 508 is acting as a relay amplifier to boost the output of collimating optics 402 after a long run through a fibre optic cable loop 510. (For clarity in FIG. 5b the pump laser for fibre amplifier 508 is not shown). The skilled person will appreciate that many other configurations are possible. For example provided that the fibre amplifier is relatively linear it may be inserted between Y coupler 502 and collimating optics 506 without great distortion of the decay curve. Generally speaking, however, it is preferable that detector 114 is relatively physically close to the output arm of Y coupler 512, that is preferably no more than a few centimeters from the output of this coupler to reduce losses where practically possible; alternatively a fibre amplifier may be incorporated within cavity 404. In further variants of the arrangement of figures multiple fibre optic sensors may be employed, for example by splitting the shuttered output of laser 102 and capturing data from a plurality of detectors, one for each sensor. Alternatively laser 102, shutter 104, and detector 114 may be multiplexed between a plurality of sensors in a rotation.

To utilize the fibre optic cavity 404 as a sensor of an e-CRDS based instrument access to an evanescent wave guided within the fibre is needed. FIGS. 6a and 6b show one way in which such access may be provided. Broadly speaking a portion of cladding is removed from a short length of the fibre to expose the core or more particularly to allow access to the evanescent wave of light guided in the core by, for example, a substance to be sensed.

FIG. 6a shows a longitudinal cross section through a sensor portion 405 of the fibre optic cable 404 and FIG. 6b shows a view from above of a part of the length of fibrc optic cable 404 again showing sensor portion 405. As previously explained the fibre optic cable comprises an inner core 406, typically around 5 μm in diameter for a single mode fibre, surrounded by a glass cladding 408 of lower refractive index around the core, the cable also generally being mechanically protected by a casing 409, for example comprising silicon rubber and optionally armour. The total cable diameter is typically around 1 mm and the sensor portion may be of the order of 1 cm in length. As can been seen from FIG. 6 at the sensor portion of the cable the cladding 408 is at least partially removed to expose the core and hence to permit access to the evanescent wave from guided light within the core. The thickness of the cladding is typically 100 μm or more, but the cladding need not be entirely removed although preferably less than 10 μm thickness cladding is left at the sensor portion of the cable. It will be appreciated that there is no specific restriction on the length of the sensor portion although it should be short enough to ensure that losses are kept well under one percent. It will be recognized that, if desired, multiple sensor portions may be provided on a single cable.

For a Dove prism the characteristic penetration depth, dₚ, of an evanescent wave, at which the wave amplitude falls to 1/e of its value at the interface is determined by:

$${d}_{p} = \frac{λ}{2 {π ( {( sin ( ϑ ) )}^{2} - {n}_{12}^{2} )}^{\frac{1}{2}}}$$

where λ is the wavelength of the, θ is the angle of incidence at the interface with respect to the normal and n₁₂ is the ratio of the refractive index of the material (at λ) to the medium above the interface. A similar expression applies for a fibre optic. Generally dₚ is less than 500 nm; for a typical configuration dₚ is less than 200 nm, often less than 100 nm.

A sensor portion 405 on a fibre optic cable may be created either by mechanical removal of the casing 409 and portion of the cladding 408 or by chemical etching. FIGS. 7a and 7b demonstrate a mechanical removal process in which the fibre optic cable is passed over a rotating grinding wheel (with a relatively fine grain) which, over a period of some minutes, mechanically removes the casing 409 and cladding 408. The point at which the core 406 is optically exposed may be monitored using a laser 702 injecting light into the cable which is guided to a detector 704 where the received intensity is monitored. Refractive index matching fluid (not shown in FIG. 7a) is provided at the contact point between grinding wheel 700 and table 404, this fluid having a higher refractive index than the core 406 so that when the core is exposed light is coupled out of the core and the detected intensity falls to zero.

FIG. 7b shows a graph of light intensity received by detector 704 against time, showing a rapid fall in received intensity at point 706 as the core begins to be optically exposed so that energy from the evanescent wave can couple into the index matching fluid and hence out of the table. With a chemical etching process a similar procedure may be employed to check when the evanescent wave is accessible, that is when the core is being exposed, by removing the fibre from the chemical etch ant at intervals and checking light propagation through the fibre when index matching fluid is applied at the sensor portion of the fibre. An example of a suitable enchant is hydrofluoric acid (HF).

Tapered fibre cavities may also be made by pulling under heating to a known radius to produce the taper. Tapered fibres prepared in this way are available from Sifam Fibre Optics, Torquay, Devon, UK. Also the telecoms industry has developed a technology for fusing fibre optics together, coupling two or more input fibres into one output fibre by tapering the fibres and fusing the cores of the incoming fibres to the output fibre. In tapering a single fibre optic some of the evanescent field is revealed from the core and samples the region outside the taper. FIG. 7c shows an example taper profile with a minimum diameter of 27 μm and a length of 27 mm (here taking the taper length as the distance between points at which the fibre has twice its minimum diameter). The taper then be spliced into a fibre cavity to form a complete sensor, as shown in FIG. 7d. In embodiments the tapered region may be supported in a ‘U’ shaped gutter. In an alternative fabrication technique mirrors are deposited onto a fibre that is appropriate for tapering; losses of the taper may then be monitored by CRDS during the taper preparation.

Tapers have been drawn in fibre with a “W” index profile but it is preferable, for reduced loss, to use fibre with a step index profile. Fibre may be obtained from Oz Optics (Ontario, Canada), An example specification (for Lot ID: CD01875XA2) is Cladding Diameter 124.72/125.51 μm, Coating Diameter 248.77/248.9 μm, Attenuation at 630 nm 7.09 dB km⁻¹, Cutoff 612.4/619.5 nm, Mean Fibre Diameter at 630 nm 4.28/4.62 μm. The losses at 633 nm are dominated by the absorption losses of the silica in the fibre and a shift to longer wavelength can allow the operation of the cavity in a region of lower losses in the absorption spectrum of the silica. The minimum absorption occurs at 1.5 μm, the telecom wavelength.

In on example a tapered fibre was then spliced into a cavity to provide an overall cavity length of 4.2 m; more than one taper could be spliced into a cavity in a similar way. The cavity length was chosen to be this length to increase the ring down time τ (which has a linear dependence on tᵣ the round trip time). To reduce the splicing losses the mirrors may be deposited onto a fibre with a desired index profile.

In another example the fibres were fabricated in two batches, one supplied and prepared with high-reflectivity mirror coatings by INO (Institute National d'Optique—National Optics Institute, Quebec, Canada), and one supplied by Oz optics with high-reflectivity mirror coatings provided by Research Electro Optics (REO), Inc, of Colorado, USA. Each fibre was polished flat as part of a standard INO preparation procedure and then connectorised with a standard FC/PC patchchord connector. For the REO batch the mirror coatings were applied to the end of the polished fibre with the FC/PC connectors in place. The fabrication process may coat the mirrors before or after connectorisation. The batch from INO was supplied as patch-chords with a rugged plastic covering around the fibres (likely added after the mirrors were coated); the batch sent to REO had no outer coating, except the silicone covering, around 1 mm in diameter to minimise out-gassing during the coating processes. Two mirror reflectivity custom coating runs were performed, by Oz Optics and by REO. Oz specified a coating reflectivity of better than 0.9995; REO specified 0.9999 or better reflectivities (manufacturer's estimates) by their standard processes.

FIG. 8 shows a simple example of an application of the apparatus of FIG. 4a. Fibre optic cable 404 and sensor 405 are immersed in a flow cell 802 through which is passed an aqueous solution containing a chromophore whose absorbance is responsive to a property to be measured such as pH. Using the apparatus of FIG. 4a at a wavelength corresponding to an absorption band of the chromophore very small changes, in this example pH, may be measured.

The above described instruments may be used for gas, liquid and solid phase measurements although they are particularly suitable for liquid and solid phase materials. Instruments of the type described, particularly those of the type shown in FIG. 1c may operate at any of a wide range of wavelengths or at multiple wavelengths. For example optical high reflectivity are mirrors available over the range 200 nm-20 μm and suitable light sources include Ti:sapphire lasers for the region 600 nm-1000 nm and, at the extremes of the frequency range, synchrotron sources. Instruments of the type shown in FIG. 4a may also operate at any of a wide range of wavelengths provided that suitable fibre optic cable is available.

Plasmon Resonance Linked eCRDS Sensing

We will now describe the use of the above apparatus for plasmon resonance based sensing. In the following text references to surface plasmon resonance should be taken as a shorthand also including other forms of plasmon resonance, including localized and particle plasmon resonance.

Evanescent wave cavity ring down spectroscopy (e-CRDS) was performed on a gold surface to use the ultra sensitivity of the e-CRDS technique to observe plasmon resonance. Fabrication of a thin gold layer of order 10 nm in thickness produced an PR signal within the tolerable losses of the e-CRDS optical cavity. AFM studies of the surface revealed a non-continuous layer with structures of micron dimensions responsible for the observed PR. Sensitivity of the surface prepared in this was were tested using bovine serum albumen (BSA) as a benchmark binding study. Un-optimised investigations performed at 637 nm showed a binding sensitivity of 10 ng ml⁻¹; the same sensitivity as that observed for the best commercial instruments.

Further gold surface were fabricated with gold nanoparticles directly from a synthesised colloid and deposited directly onto an un-functionalised silica surface. Surface plasmon resonance measurements were performed at 637 nm on the nanofabricated surface using binding studies of Bovine Serum Albumin. The binding curve for BSA was observed for the nanofabricated surface with a detection limit of 1 g ml⁻¹ for the un-optimised surface. Nanoparticle surface fabrication from a controlled colloid preparation has improved the detection limit of BSA by SPR to 10 femtograms per ml.

Excitation of the surface plasmon resonance (SPR) in gold and other materials can be achieved using the evanescent field resulting from a total internal reflection event at the interface between two media with refractive indices n₁ and n₂. Once excited the surface plasmon propagates ˜50 μm along the gold surface with an excitation bandwidth in both angle space and wavelength space. For a 100 nm thick continuous gold layer the wavelength is 632.8 nm at an angle of 42°, when excited with p-polarised radiation. The absorbance is strong such that a 100 nm layer excited at both maxima would remove all radiation from a typical laser source of 10 mW incident power. The absorption maxima in either wavelength or angle space shows a shift in response to a change in the refractive index typically induced by the binding of a material to the gold surface and this shift either in wavelength or angle is used as the basis for the commercially available SPR instruments.

Extension of the SPR to utilise the evanescent wave cavity ring down detection (e-CRDS) technology preferably requires the absorption losses by the plasmon at the surface to be less than 1% per pass. Continuous gold surfaces even thin layers show considerable plasmon absorbance at 637 nm. Confining the plasmon in a particle however can tune the strength of the absorbance as a function of particle size. The plasmon no longer has a broad absorbance in wavelength space but has a narrow resonance of order 50-100 nm wide centred at a wavelength dependent on the size of the particle. In embodiments there is no angle dependence or polarisation dependence of the plasmon excitation in the particle.

Controlling the plasmon absorbance strength by designing a nano-fabricated surface enables the loss budget of e-CRDS to be maintained and the extension of the ultra-sensitivity of this technique can be applied to SPR. We present results regarding the thiol-functionalisation of the prism surface to enhance gold particle deposition, variation of the particle deposition coverage and variation of the coupling conditions of the laser radiation to the surface. These experiments were performed with a variety of surface functionalisation reactions, particle preparation conditions and coupling configurations. Binding studies on the new surfaces were performed with the protein bovine serum albumin (BSA) to act as a benchmark. The particles may touch, aggregate or be completely isolated.

For background prior art reference can be made to:

D. A. Schultz, Current Opinion in Biotechnology 14 (2003) 13.

H Xu and M. Kall, Sensors and Actuators B, 87 (2002) 244.

R. Slavik, J. Homola, J. Ctyroky, and E Brynda, Sensors and Actuators B, 74 (2001) 106.

D. A. Shultz, Plasmon Resonant particle for Biological Detection in Current Opinion in Biotechnology, 14 (2003) 13-22.

K. L. Kelly, E. Coronado, L. L. Zhao and G. C. Schatz, J. Phys. Chem. B, 107 (2003) 668.

J. J. Mock et al. J. Chem. Phys. 116 (2002) 6755.

A. M. Shaw, T. E. Hannon, F. Li and R. N. Zare J. Phys. Chem.B 107, (2003) 7070. 17

Silberzan et al. Langmuir, 1991, 7, 1647-1651

J Diao, Journal of Physica d: Applied Physics, 36, 2003, 125-L27

R Sigmoudy, Nobel Lecture, Dec. 11, 1926

J Tseng et al, Colloids and Surfaces A. Physicochemical and Engineering Aspects, 2001, 182, 239-245

Faraday, M. Philos. Trans. R. Soc. London. 1857, 147, 145.

Turkevitch, J.; Hillier, J.; Stevenson, P. C. Disc. Farad. Soc. 1951, 11, 55.

The preparation of a continuous gold layer on a fibre optic sensor surface has provided an observed SPR effect but with a polarisation dependence in the excitation. SPR has also been observed in fluorescence from nanostructured gold and silver particles with the potential for use in biological detection in solution. Plasmon structure in nanoparticles has been observed and there is some reasonable understanding of the SPR structure of spherical particles; this does not extend to non-spherical particles.

Experiments were performed in a Dove cavity in a free-running cavity configuration on an instrument as described above. The light source was a cw diode laser centered at 639 nm with a 5 nm bandwidth. The light source is chopped at 9 kHz to allow the ring-down of the optical cavity to be observed. The cavity is formed from two high reflectivity mirrors (R>0.999, Layertech) arranged in a linear configuration. A Dove prism is placed within the cavity to act as a total internal reflection element, which preservers the optical alignment of the cavity. Antireflection coatings are placed on the legs of the prism to minimise the reflection losses from the surfaces and to preserve the Q of the cavity. Typical ring-down times for an empty cavity including the Dove prism are 400 ns with a standard deviation στ/τ˜2% or better, for example down to 0.01%. A flow cell has been designed to cover the evanescent field produced at the total internal reflection element and all solutions are flowed over the surface using a HPLC pump. All e-CRDS experiments on the functionalised prism surfaces were performed with the free running Dove cavity configuration.

A flow cell may be designed as follows: a glass flow cell is fabricated from a small 1 mm bore glass capillary tube and formed into a U-shaped vessel. Part of the outer glass wall is ground flat through to half-way through the capillary bore, exposing a length of the capillary of order 25 mm and a width of 2 mm. This region is sufficient to allow the evanescent field to be completely covered on the back surface of the Dove prism. In another example a single-pass flow cell for a Dove prism was constructed from polytetrafluoroethene (PTFE) with a flow channel matched to the prism width of 10 mm machined into the underside of the block. Once clamped and sealed to the upper prism surface with a 1 mm thick nitrile ‘O’-ring, the flow cell volume was 190 μl. Samples were allowed to flow through the cell with a maximum flow rate of 4 ml per hour from a syringe pump; this corresponded to a maximum linear flow velocity of 0.14 mm s⁻¹. The velocity of the flow through the cell determines the rate of transfer of molecules from the bulk solution to the surface. Calculation of the flow Reynolds Number indicates the type of flow regime present within the cell. This is found from:

$$Re = \frac{ρ \times u \times d}{μ}$$

where ρ is the fluid density, u is the flow velocity, d is the characteristic flow dimension and μ is the fluid viscosity. Assuming fluid viscosity and density to be equal to that of water at 25° C. (i.e 0.8909×10⁻³ N s m⁻² and 998 kg m⁻³ respectively) with a cell dimension of 1 mm, the Reynolds Number is 0.16. With highly viscous, laminar flow in ducts existing up to Reynolds Numbers exceeding 1, this value indicates that the flow regime within the cell was truly laminar and thus diffusion limiting conditions prevailed. At such slow flows, the laminar boundary layer is estimated to be fully developed within 1 μm of the cell entrance.

All prism surfaces were cleaned prior to fabrication by clamping them to a custom doping apparatus and sealed using a Teflon gasket. An airtight seal was achieved and tested using ultra pure 18 MΩ cm⁻¹ water and the prisms were dried by heating the empty apparatus to 100° C. for 20 minutes. Piranha solution (H₂O₂: H₂SO₄ 1:3 (v/v)) was placed in the apparatus and the entire device was tilted to 25 degrees in a sand bath to ensure even contact with the solution. The piranha solution was heated under reflux conditions for 1 hour at 80° C. followed by exhaustive washing in situ with ultra pure 18 MΩ cm⁻¹ water to remove any traces of the piranha due to its explosive nature in the presence of organic solvents. The prism was again dried as previously outlined.

Following cleaning, prisms were covered using glass slides to protect the surfaces 1 nm were deposited by electron beam evaporation (using a BirVac electron beam evaporator) in a glass vacuum chamber with a base pressure of approximately 10⁻⁶ mbar. The gold used was 99.999% pure (Sigma). The film thickness after deposition was measured using an oscillating quartz crystal set in the chamber as close as possible to the specimens to be coated. This has an accuracy of ±10% for films up to a thickness of 50 nm. Surfaces flashed with chromium were also investigated but this was found to absorb all the light from the cavity and therefore was not used. All surfaces were gently cleaned using a drop and drag method with lens tissue and methanol; this was believed to remove the gold with the highest affinity for the silica surfaces.

There are a number of methods for preparing gold colloids outlined in literature, all have one thing in common which is the reduction of a gold salt to form the colloid. There are however many differences, the reducing agent, the solvent, concentrations and temperature. All of the above affect the particle size formed (Silberzan; Diao; Sigmoudy; Ibid; hereby incorporated by reference.

The simplest preparation used involved a sodium citrate reduction of HAuCl₄. This prepares a colloid of deep red colouration which is indicative of particles approximately 40 nm although UV/Vis spectroscopy showed a broad absorption peak meaning that a wide distribution of sizes has been formed. The method has been modified with only 350 mg of disodium citrate used to provide a more monodisperse colloid with an approximate particle size of 15 nm, FIG. 9a. An alternative preparation utilizes an organic solvent system and sodium borohydride as the reducing agent. No binding studies have been made as of yet using this colloid. When this preparation was attempted a colloid of an orange red rather than deep red was obtained. This is a characteristic of particles approximately 5 nm in size. Hexadecyltrimethyl ammonium bromide is used as stabilizing agent in this method. (Tseng, Ibdid, hereby incorporated by reference).

Commercial colloid was purchased from Sigma with a 5 nm particle size, stabilised with “commercial” stabilising agents that are not revealed by the supplier. These samples were used as supplied.

For aqueous colloid preparation (http://mrsec.wisc.edu/edtec/cineplex/gold.html) HAuCl₄ (10 mg, 0.25 μmol) was dissolved in 95 ml of ultra-pure water. The solution was heated to boiling point. Sodium citrate dihydrate (350 mg, 1.7 mmol) dissolved in 5 ml of ultra-pure water was added rapidly. The resulting solution was left to reflux with stirring for 1 hour to yield 100 ml deep red solution. UV/Vis˜520 nm, FIG. 9. Reference may also be made to Turkevitch, et al., ibid.

For organic colloid preparation HAuCl₄ (17 mg, 0.43 μmol) was dissolved in 100 ml of ultra pure water to yield 25.4 mM aqueous hydrogen tetrachloroaurate as a pale yellow solution. Ethanol Solution of Hexadecyltrimethylammonium Bromide (CTAB) CTAB (73 mg, 0.18 mmol) was dissolved in 10 ml of ethanol to yield 20 mM ethanolic solution of CTAB as a clear colourless solution Ethanolic Sodium Borohydride NaBH₄ (57 mg, 1.5 mmol) was dissolved in 10 ml of ethanol to yield ethanolic sodium borohydride as a clear colourless solution.

Aqueous solution of hydrogen tetrachloroaurate (1.78 ml, 25.4 mmol dm⁻³), 8.22 ml of chloroform and 0.4 ml of a 20 nmM ethanolic solution of CTAB were mixed and stirred at room temperature for 10 minutes. To this solution freshly prepared ethanolic NaBH₄ (0.8 ml, 0.15M) was added and left for 30 minutes with vigourous stirring. The orange/red organic phase was separated to yield a gold colloidal solution.

FIG. 9 shows absorption spectrum for 350 mg of disodium citrate gold colloid for a) aqueous colloid preparation colloid, b) organic colloid preparation; both have a particle size distribution centred at 15 nm. For BSA titrations a swan-necked flow cell was been designed to allow liquid to flow over the prism surface with a volume of approximately 3 ml. The prism was placed in the cavity and a silicon gasket between the flow cell and the prism to expose as much of the prism surface to the liquid as possible. Liquid flowed over the surface at a rate of 2.5 ml/min using the HPLC pump with Teflon tubing. A series of BSA dilutions 1 ng-1 mg/ml were made up in a 10 mM phosphate buffer solution (PBS) containing Na₂HPO₄ (1.640 g), NaH₂PO₄ (0.470 g) and NaCl (8.770 g), all dissolved in 1 litre of distilled water and adjusted to pH 7.2 (using HCl). The one notable difference in the procedure for the colloids followed was the angle at which the prism was aligned within the cavity. The cavity was aligned at approximately 55° so as to maximise the signal and t before a standard method of titration was carried out.

For evaporated gold surfaces tapping mode AFM images of a gold surface are shown in FIG. 10 revealing micron sized particles ranging from 0.5-10 μm in length that are responsible for the SPR signal. The surface is clearly not covered with these particles. FIG. 10 shows AFM studies of the evaporation-deposited gold surfaces.

From these images it is evident that islands of gold were present on the surface of the prism. The area roughness parameter Rₐ for the gold-coated surface and a non-gold coated surface were measured and found to be 3.35±0.93 nm and 36.5 nm±8.2 nm respectively. The gold deposited surface appears to have islands of different size formed from the initial deposition layer of 1 nm. These irregular particle shapes will have a plasmon resonance similar to that of te bulk gold film and will be excited by the 637 nm radiation of the laser.

Binding studies were performed with BSA to monitor the change in refractive index on the plasmon resonance. The results from these studies are shown in Figure and show clearly a detectable change for 10 ng ml⁻¹ for BSA for these un-optimised surfaces. The kinetics of the binding curve for BSA is shown in Figure . BSA shows a simple kinetic binding to the gold island surface with a small wash-off with added buffer solutions.

FIG. 11 shows SPR response for BSA binding studies; FIG. 12 shows BSA binding curve kinetics.

Salt destabilized particle aggregates have also shown to provide extremely sensitive surfaces, even down to an attomolar level (say use the method of Turkevitch, at al, ibid, to make a colloid then add salt, for example 1:1 sodium chloride electrolyte, to a threshold level such as 0.1M). The colloidal suspension of nanoparticles is maintained by the protection of the citrate ligands and the charged bilayer around the particles. Adding salt causes the bilayer to contract allowing the particles to get closer to one another forming aggregates of particles containing about 150 particles which appear to naturally stick to a TIR surface/interface and which provide nicely localised plasmon spectra.

For gold particle fabricated surfaces gold particle deposition was implemented by the preparation of the colloid particles outlined above without any preservatives or stabilisers in three ways: 1) using the drop-and-drag to add a thiol functionalised surface; 2) similarly for an amino functionalisation; and 3) a cleaned prism surface. Absorption of gold to a clean prism 1302 thiolated 1304 and aminated 1306 surface is shown in FIG. 13 from a single drop of the colloid of fixed volume. The clean un-functionalised surface with the un-protected colloid particles showed the best absorption profile. FIG. 13 shows absorbance change with time for 0.01 ml gold on prism surface.

The simplest reaction scheme for the deposition of the a bare colloid onto an un-functionalised surface proves to be the most successful gold particle surface fabrication method with controllable deposition kinetics revealed by flowing a solution of the gold colloid over the surface, FIG. 14. The rate of deposition and degree of coverage can be controlled by dilution of the initial colloid solution. FIG. 14 shows absorption kinetics of 15 nm gold colloid onto the prism surface.

The absorbance change shown in FIG. 14 is formally the losses in the cavity at the wavelength of the radiation, 637 nm. The nanoparticles will scatter the radiation reducing the ring down time of the cavity but the particle plasmon will also absorb radiation if the radiation falls within the resonance bandwidth. The colloid particle distribution is not monodispere with a mean particle size of 15 nm as determined (crudely) by UV/Vis spectroscopy. Particles within this distribution will have a plasmon resonance at 637 nm and will absorb strongly. It is preferable to tune the particle resonance with respect to the excitation wavelength to minimise the surface scatter losses and maximise the plasmon absorption.

BSA binding studies were performed on the un-optimised gold colloid surfaces to determine the sensitivity of the surface to protein binding. Initial results show a variation absorbance of the gold surface with 1 gl⁻¹ of BSA, FIG. 15. Control experiments suggest that the absorbance variation is not due to scatter on a bare prims surface and the observed trends are attributed to a shift in the plasmon resonance of the particles contributing to plasmon resonance absorbance in the baseline absorbance of the functionalised surface. FIG. 15 shows absorbance variation with time for 1 gl⁻¹ BSA on gold colloid at 55°.

Studies into the angle dependence of τ were also carried out. The procedure used involved an attempt at maximising the observed value of τ at each of the angles measured. A maximum τ is observed between 55° and 60°, which balances the efficiency of the evanescent wave coupling with the scatter and absorption losses.

The careful construction of the colloid allows the SPR resonance maximum wavelength to be brought in tune with the excitation wavelength, presently at 637 nm.

The synthesis of colloidal gold nanocrystals used the Citrate (Frens) Method (Faraday, Ibid, incorporated by reference):

Aqua regia (3 parts HCl, 1 part conc. HNO₃);

HAuCl₄, 1 mM (aq.), −5 mM approx 100 mL;

Na₃C₆H₅O₇ (trisodium citrate), 38.8 mM, (aq.);

Nanopure water (regular DI water may not be good enough)

Aqua regia solution was prepared and used to clean all glass were this was followed by a piranha clean at 80° C. for 30 minutes. All glassware was then thoroughly rinsed with Nanopure water. 100 mL of the HAuCl₄ stock solution was poured into the flask and heated to 90 degrees until condensation is noted on the neck of the flask. 10 mL of the citrate stock solution was measured out. The citrate was added as quickly as possible. The pale yellow colour of the solution faded to a very faint blue within about a minute. Then, the colour will slowly turn to a deep purple to a wine-red. The final colour depends on how much citrate is added to the reaction, the temperature at which the addition occurred, as well as other factors. After the colour change is complete, the reaction was run for another 15-20 minutes before removing the heat and stopping the stirring. The solution was cooled to room temperature. To improve the monodispersity of the solution, a filter can be used. Store in an amber bottle at 4° C. for longest shelf life. The amount of citrate added, or more correctly, the ratio of gold to citrate is the dominating factor in resultant nanocrystal size. There is a limiting minimum diameter that can be obtained with this method before aggregation occurs as a result of an excess of citrate.

The variation in temperature during the gold production process is an important parameter for determining the particle by controlling the flocculation kinetics. This must be optimised for the target surfaces. The variation of the colloid visible absorption spectrum is shown in FIG. 16 and shows a red-shifted maximum associated with lower temperatures. Longer wavelength scatter is associated with larger colloid particles. FIG. 16 shows visible absorption spectrum variation with colloid preparation temperature.

The variation of the gold salt concentration in the colloid preparation procedure outlined above changes the flocculation and formation kinetics of the nanoparticles in the colloid. The variation of the visible spectrum of the colloid with gold conentration at a constant preparation temperature of 25° C. is shown in FIG. 17.

Similar measurements were made for a smaller concentration range with a 95° C. preparation temperature as shown in FIG. 18. Both figures show that higher concentrations of the gold salt show an increase in the absorbance spectrum to longer wavelengths consistent with a larger particle size. FIG. 18 shows variation in visible spectrum of the colloid with gold salt concentration at 95° C.

The absorption kinetics of the gold colloid particle assembling on the prism surface can be observed in real time on the e-CRDS apparatus. The variaton in τ with colloid concentration is shown in FIG. 19 and FIG. 20 and summarised in FIG. 21: FIG. 19 shows a 10% colloid solution absorption kinetics followed by added water; FIG. 20 shows 50% colloid solution absorption kinetics followed by added water; and FIG. 21 shows τ variation with colloid concentration.

The deposition of the colloid and the optical losses at the surface of the prism can thus be controlled by the concentration of the colloid during the experimental fabrication of the surface. The optical absorbance show no significant angle dependence in excitation as would be expected for the gold surface.

The sensitivity of the surface prepared with the different gold recipes has been assessed as before with the binding of the benchmark protein BSA. The results are shown in FIG. 22. Here the binding of BSA has been observed in real time to the nanofabricated gold surface with a sensitivity of 1 pg ml⁻¹. The ring down time τ varies from 180 ns to 110 ns during the binding event suggesting that a minimum detectable sensitivity for BSA is nearer to 100 femtogram ml⁻¹. The binding with the BSA protein appears irreversible. FIG. 22 shows a binding curve measured in real time for 1 pg ml⁻¹ of BSA.

The surface used for the results shown in FIG. 22 is for a 10 mM gold salt solution with 3.38 mM citrated forming the colloid at 25° C. The colloid was allowed to flow over the surface producing a change in τ of 180 ns from the clean gold surface. The plasmon resonance for the nanofabricated surface is clearly close to 637 nm for some of the particles and it is these particles that show the sensitivity to the protein binding. Bringing the plasmon absorption into resonance with the laser radiation at any wavelength can thus be controlled by the particle size. Colloid preparations are also available to produce triangular or cubic particles.

We have described how preparation of a gold nanoparticle fabricated surface has been achieved by preparation of an un-protected colloid deposited directly onto a clean un-functionalised silica surface. It is desirable (but not necessary) to fabricate colloid particles with a narrow distribution of known plasmon resonance wavelength so that the absorbance losses dominate the scatter losses. Excitation of the resonance directly will then be a sensitive measure of the refractive index surrounding the particle: e.g. the bound protein. The potential of gold nanoparticle functionalised surface as a plasmon-based sensor has been demonstrated.

Optimisation of the particle size and plasmon excitation wavelengths will allow the losses at the surface and the response of the plasmon to binding proteins to be optimised. Controlled deposition of the particles onto the surface may maximise the plasmon absorbance and minimise the scatter. Control of protein binding to the nano-fabricated surface may optimise the detection technology. Complete organisms may be detected; protein folding and conformational changes may also be visible using the particle-confined plasmons. Functioanlisation of the smart gold surfaces with antibodies can make available specific sensing on the surface: For example 4500 primary monoclonal antibodies are available commercially; and receptors are available commercially and can be added to self-assembled monolayer functionalised surfaces to enhance the detection of low-mass ligands by plasmon resonance. The simple surface preparation facilitates implementation using fibre optic technology.

Other electrically conducting materials which may be used include silver, copper, TiN (Titanium Nitride), and any materials showing a plasmon resonance anywhere within the electromagnetic spectrum.

Potential applications include: biowarfare detection; pathogen detection; chemical agent detection; complete organism detection; spore detection or anthrax sensors; bio-fouling detection in hydraulic fluid, lubricants and fuel oil; immuno assays detecting antibodies in blood such as AIDS; prion detection in blood samples—made possible by the low-mass limit improvements; blood screening for known agents; and the use of poly-clonal antibodies for broad-spectrum detection.

Some specific further examples of applications of the above technology will now be described in more detail. A Ca²⁺ sensor may be based on the configurational changes in calmodulin on Ca²⁺ binding. This demonstrates enzyme/protein specificity for the “biophotonic” interface or “chemo-photonic” interface (we use the terms interchangeably). SPR can also be used for the detection of antibody-antigen binding events, for example for constructing an insulin sensor based on an insulin antibody, or for detecting the bacterium E. coli as an example of a microbe detection sensor. This demonstrates the antibody-antigen binding specificity for the biophotonic interface

In embodiments the colloidal gold particles may be bonded to the surface using TMMS with an —SH group, which is a functionality known to attract gold; there is a well-established literature of binding proteins and other materials to gold particle surfaces. In embodiments the SPR surface integrity may be protected by treating it with a trimethoxyniethyl sylane to cap exposed groups.

We next describe a SPR configuration for a calmodulin Ca²⁺ sensor using a thin film of gold, for example around 45 nm thick on a silica surface.

Absorption of proteins onto gold surfaces usually results in denaturation and loss of biological activity and preferably therefore the surface is prepared with a layer of mercaptoproprionic acid before adsorption of the protein calmodulin. Calmodulin changes shape on binding 4 Ca²⁺ ions and this conformational may be detected by SPR. A potential may be applied to the surface to reset the sensor after Ca²⁺ binding; this may induce the dissociation of the Ca²⁺, refreshing the sensor surface for further detection.

We next describe antibody sensors and prototype insulin and E. Coli sensors. Incorporating an antibody onto the SPR sensor configuration demonstrates the immunoselective potential of the technology. Well over 200 antibodies are available commercially and antibodies for insulin and E. coli are chosen to demonstrate this application. Deposition of antibodies onto a gold surface is a well-established technique and standard preparation procedures may be used to prepare an antibody array on the surface of the sensor. Measuring the charge distribution at the surface with a molecular probe can be used to monitor the coverage of the surface and the density of the antibodies

Insulin antibodies may be assembled on the gold surface and known concentrations of insulin passed over the prototype sensor to calibrate the sensitivity to insulin in buffered solution. Solutions of different buffer concentration may be washed over the sensor to refresh the surface. A system may be provided to flow such a solution over the sensor when refresh is desired. Reversing an applied potential to the surface may also be used for refreshing the antibody sensor surface. Thus additionally or alternatively a refresh system for an eCRDS-SPR sensing device may comprise one or more electrodes connected to the surface; in embodiments an associated refresh power supply may also be provided. Similar techniques may be employed with the bacterium E. coli for detecting a live organism.

Enzymes in the body, for example, are able to tell the difference between glucose and sucrose and this selectivity can be harnessed as the primary recognition event in chemical sensing, for example for monitoring blood and urine sugar levels. The specificity of the DNA and RNA base pair interactions make the detection of a specific sequence possible. An example is mRNA found in eukaryotes and is terminated with the base sequence -AAAAA on the tail. Mounting a -TTTTT sequence gives the right binding for the A-T base pair and would attach the mRNA to the sensor surface. This may then be varied to produce a DNA or RNA specific sequence detector that might be used, for example, in the detection of DNA labels used in anticounterfeiting work.

Biological recognition processes can be based around the specific interactions of immunoglobins or antibodies, with target proteins or antigens. These interactions can either have broad specificity and respond to many similar molecules (polyclonal) or can be highly specific responding, for example, to one type of virus or bacterium from a mixture of similar strains (monoclonal). As previously mentioned this immunochemistry may be applied to the surface of a sensor. Hundreds of antibodies are commercially available raised specifically to antigens, as diverse as heavy metals, anthrax, salmonella, insulin and E.coli for example, and can be used to make a large number of different biosensors.

No doubt many effective variants will occur to the skilled person and it will be understood that the invention is not limited to the described embodiments but encompasses modifications apparent to those skilled in the art found within the spirit and scope of the appended claims.

1-26. (canceled)

27. An evanescent wave cavity-based optical sensor, the sensor comprising:
an optical cavity formed by a pair of highly reflective surfaces such that light within said cavity makes a plurality of passes between said surfaces, an optical path between said surfaces including a reflection from a totally internally reflecting (TIR) surface, said reflection from said TIR surface generating an evanescent wave to provide a sensing function;
a light source to inject light into said cavity; and
a detector to detect a light level within said cavity;
wherein said TIR surface is provided with an electrically conducting material over at least part of said TIR surface such that said evanescent wave excites a plasmon within said material; and
wherein a change in absorption of said evanescent wave due to a change in said plasmon excitation is detectable using said detector to provide said sensing function.

28. A sensor as claimed in claim 27 wherein said optical cavity comprises a fibre optic sensor including a fibre optic, said fibre optic having a core down which light propagates by total internal reflection (TIR), and wherein said fibre optic has a region including a sensing surface at least partially coated with said electrically conducting material, wherein said sensing surface comprises said TIR surface, and wherein at said sensing surface said core is sufficiently exposed to provide an evanescent field from light guided within the fibre to said conducting material to excite said plasmon in said conducting material for said sensing.

29. A sensor as claimed in claim 27 wherein said light source is configured to provide light at two wavelengths straddling said plasmon excitation.

30. A sensor as claimed in claim 27 wherein said conducting material comprises one or more of islands or aggregates of conducting material; and wherein said plasmon comprises a localised plasmon.

31. A sensor as claimed in claim 27 wherein said electrical conducting material comprises generally planar metallic regions having an average size of less than 50 μm.

32. A sensor as claimed in claim 31 wherein said regions comprise irregular islands.

33. A sensor as claimed in claim 27 wherein said electrical conducting material has a non-particulate structure.

34. A sensor as claimed in claim 27 wherein said conducting material comprises a substantially continuous film and wherein said plasmon comprises a surface plasmon.

35. A sensor as claimed in claim 27 wherein said sensor is a cavity ring-down sensor, wherein said cavity is a ring-down optical cavity for sensing a substance modifying a ring-down characteristic of the cavity; wherein said light source comprises a continuous wave light source for exciting said cavity; and wherein said detector is configured to monitor said ring-down characteristic, said sensed substance modifying said cavity ring-down characteristic.

36. A sensor as claimed in claim 27 wherein said conducting material is bound to said TIR surface/interface by a molecular link.

37. A sensor as claimed in claim 27 wherein said conducting material comprises gold.

38. A sensor as claimed in claim 27 further comprising a functionalising material associated with said conducting material to provide a selective response for said evanescent wave plasmon sensing.

39. A sensor for a cavity of an evanescent-wave cavity ring down device, the sensor comprising a fibre optic cable having a core configured to guide light down the fibre surrounded by an outer cladding of lower refractive index than the core, wherein a sensing portion of the fibre optic cable is configured have a reduced thickness cladding provided with an electrically conducting material such that an evanescent wave from said guided light is able to excite a plasmon within said material.

40. An optical cavity-based sensing device comprising:
an optical cavity absorption sensor comprising an optical cavity formed by a pair of reflecting surfaces;
a light source for providing light to couple into said cavity; and
a light detector for detecting a level of light escaping from said cavity;
wherein said optical cavity includes a plasmon-based sensing device, said device comprising a layer of conducting material with a functionalised surface; and wherein said functionalising surface comprises a biological entity selected from the group consisting of a protein, a monoclonal antibody, a polyclonal antibody, RNA, and DNA.

41. A sensor as claimed in claim 40 wherein said sensor is a cavity ring-down sensor, wherein said cavity is a ring-down optical cavity for sensing a substance modifying a ring-down characteristic of the cavity; and wherein said detector is configured to monitor said ring-down characteristic.

42. A plasmon-based sensing device comprising a sensing surface bearing a layer of conducting material, and including a sensing surface refresh system.

43. A plasmon-based sensing device as claimed in claim 42 wherein said layer of conducting material has a functionalised surface.

44. A plasmon-based sensing device as claimed in claim 42 wherein said sensing surface refresh system comprises a system for applying an electrical charge or potential to the conducting material to refresh the device.

45. A method of refreshing a plasmon-based sensing device, the device comprising a layer of conducting material with a functionalised surface, the method comprising applying an electrical charge or potential to the conducting material to refresh the device.

46. A method as claimed in claim 45 further comprising switching said electrical charge or potential between a first, sensing state and a second, refreshing state.

47. A method as claimed in claim 46 wherein said switching comprises reversing said electrical charge or potential.
